(19) United States
(12) Patent Application Publication
(10) Pub. No.: US 2014/0158020 A1
(43) Pub. Date: Jun. 12, 2014

(54) Ice-Tempered Hybrid Materials

(71) Applicants: Ulrike G.K. Wegst, Hanover, NH (US); Philipp M. Hunger, Pittsburgh, PA (US)

(72) Inventors: Ulrike G.K. Wegst, Hanover, NH (US); Philipp M. Hunger, Pittsburgh, PA (US)

(73) Assignee: THE TRUSTEES OF DARTMOUTH COLLEGE, Hanover, NH (US)

(21) Appl. No.: 13/984,235

(22) PCT Filed: Feb. 7, 2012
(86) PCT No.: PCT/US2012/024200

§ 371 Date: Feb. 20, 2014

Related U.S. Application Data
(60) Provisional application No. 61/440,255, filed on Feb. 7, 2011.
(60) Provisional application No. 61/440,695, filed on Feb. 8, 2011.

(51) Int. Cl. C08L 5/08; C08L 89/00; C08K 7/20

(52) U.S. Cl. CPC C08L 5/08; C08K 7/20; C08L 89/00
USPC 106/135.1; 106/217.9; 428/403

(57) ABSTRACT

A metal-polymer composite scaffold includes metal particles coupled with polymer binder, the scaffold having regions of aligned porosity with a gradient. In a particular embodiment, the metal particles include stainless steel. The metal particles have sizes equal to or smaller than 3 μm. The scaffold has Young's modulus is below 950 MPa. The polymer binder includes chitosan and gelatin. The composite also includes ethanol. The composite has porosity of at least 70%. Systems and methods for producing such metal polymer composite scaffold are also provided.

### CROSS-REFERENCE TO RELATED APPLICATIONS

This PCT application claims the benefit of the filing date of U.S. Provisional Patent Application No. 61/440,695, filed Feb. 8, 2011, entitled “Hierarchical Structured Composite Materials,” and U.S. Provisional Patent Application No. 61/440,255, filed on Feb. 7, 2011, entitled “Ice-Tempered Hybrid Materials,” the entire content of each of the above applications is incorporated herein by reference.

### GOVERNMENT INTERESTS

This invention was made with government support under contract DE015633 awarded by NIH and by contract DE-AC07-051D14517 awarded by DOE. The government has certain rights in the invention.

### BACKGROUND OF THE INVENTION

Many applications such as filters, catalyst carriers or tissue scaffolds require highly porous, yet mechanically strong scaffolds whose micro- and nanoarchitecture can be carefully tailored. Because the introduction of porosity significantly lowers the mechanical properties of a material, it is difficult to achieve a successfull compromise between porosity and mechanical performance. Furthermore, it is a great challenge to modify structure and mechanical performance independently.

Nacre is of considerable interest because of its exceptional property profile, such as high stiffness and strength with high toughness. Nacre is a fully dense material with a brick-and-mortar structure composed of 95 vol % ceramic (aragonite) platelets and 5 vol % polymer (protein) glue. A number of published studies describe various processing routes. However, these are limited by the small sample sizes that can be generated—frequently films of only several tens of micrometers in thickness—and highly labor intensive processing techniques, such as the layer-by-layer assembly of micrometer-sized ceramic platelets. Only one method produces larger scale samples, but results in much coarser structural features than those of the natural material. It relies on the infiltration of a porous ceramic scaffold with a polymer prior to crushing, producing fully dense nacre-like materials.

### BRIEF SUMMARY

This disclosure advances the art and overcomes the problems outlined above by providing devices and methods for freeze casting of metal-polymer composite, ceramic-polymer composite and polymer-ceramic composites. Through freeze casting and by taking a biomimetic approach it is possible to create composite scaffolds whose mechanical properties and hierarchical architecture can be controlled over several orders of magnitude and at several length scales.

In an embodiment, a metal-polymer composite scaffold includes metal particles coupled with polymer binder, the scaffold having regions of aligned porosity with a gradient. In a particular embodiment, the metal particles include stainless steel. The metal particles have sizes equal to or smaller than 3 μm. The scaffold has Young's modulus is below 950 MPa. The polymer binder includes chitosan and gelatin. The composite also includes ethanol. The composite has porosity of at least 70%.

In an embodiment, a ceramic-polymer composite includes alumina and polymer binder, the composite having regions of aligned porosity with a gradient. In a particular embodiment, the composite has a porosity of at least 90%. The polymer binder includes chitosan and gelatin. The alumina is in a form of particles or platelets. The composite formed with the alumina in the form of platelets has less shrinkage and improved yield strength and Young's modulus than a ceramic-polymer composite formed with the alumina in the form of particles. The alumina particles have diameters in the range of a few hundred nms. The alumina particles have diameters in the range of approximately 10 μm. The alumina particles include a first portion of particles with diameters in the range of a few hundred nms and a second portion of particles with diameters in the range of approximately 10 μm.

In an embodiment, a multi-functional polymer-ceramic composite includes glass beads and polymer binder; the composite having regions of aligned porosity with a gradient. In a particular embodiment, the glass beads are selected from a group consisted of hollow beads, solid beads, and flakes. The polymer binder includes chitosan. The multi-functional polymer-ceramic composite has a reflectivity above 80% in a visible and IR spectra ranging from 250 nm to 2500 nm. The multi-functional polymer-ceramic composite has thermal conductivity below 0.1 W*m⁻¹K⁻¹. The glass beads have sizes ranging from 2 μm to 25 μm.

Additional embodiments and features are set forth in part in the description that follows, and in part would become apparent to those skilled in the art upon examination of the specification or may be learned by the practice of the invention. A further understanding of the nature and advantages of the present invention may be realized by reference to the remaining portions of the specification and the drawings, which forms a part of this disclosure.

### BRIEF DESCRIPTION OF THE DRAWINGS

FIG. 1 is a schematic diagram of a freeze caster set up in an embodiment.

FIG. 2 is a P-T phase diagram of water with a path of freeze casting and freeze drying in an embodiment.

FIG. 3 is a schematic flow chart of a freeze casting process in an embodiment.

FIG. 4 is an X-ray tomographic reconstructions of a freeze cast ceramic composite sample with a diameter of 0.6 mm. Freezing rate: 20 C/min (a) and 5 C/min (b) in an embodiment.

FIG. 5 is a SEM image illustrating anisotropic growth of lamellar ice in an embodiment.

FIG. 6 is a simplified diagram illustrating lamellar crystals with their c-axis (<0001>) growing along a-axis (<1120>) in an embodiment.

FIG. 7 is a schematic representation of the general microstructure of porosity within a freeze cast sample in an embodiment.

FIG. 8 is a plot of plateau strength against Young's modulus for scaffolds including different particles sizes of particles and size distributions, frozen at two different freezing rates of 1° C./min and 10° C./min in an embodiment.

FIG. 9 illustrates scanning electron micrographs of composite cell walls of hybrid scaffolds made from a) small particles b) bimodal particles c) large particles. Scale bar is 5 μm in an embodiment.

FIG. 10 is a representative compression curve for scaffolds made from small particles in an embodiment.

FIG. 11 is a representative compression curve for scaffolds made from large particles in an embodiment.

FIGS. 12A-C are three SEM images of 316L stainless steel scaffolds from the third sintering trial at 1150° C. in an embodiment.

FIGS. 13A-B illustrate two SEM images of cross sections (perpendicular to the freezing direction) from samples S10 (a) and S10E (b) in an embodiment.

FIG. 14 is a SEM image indicating how the pore sizes and wall thicknesses were measured. in an embodiment

FIGS. 15A-D are four tomographic reconstructions of samples S10 (a, b) and S10E (c, d). Images a and c show a full 3D reconstruction of the samples. The colored planes on the cubes shows a cross section perpendicular to the scaffold's freezing direction. Images b and d show these cross sections in 2D. The cubes and cross sections had 1 mm side lengths in an embodiment.

FIG. 16 is a typical compressive stress strain curve for a 316L stainless steel freeze cast sample in an embodiment.

FIG. 17 is a graph showing the yield strength versus Young's modulus of the samples in an embodiment.

FIG. 18 is a graph showing relative Young's modulus plotted against relative density in an embodiment.

FIG. 19 is a graph showing relative yield strength plotted against relative density in an embodiment.

FIG. 20 is a plot of yield strength against Young's modulus for scaffolds including different particles sizes and size distributions, frozen at two different freezing rates of 1° C./min and 10° C./min in an embodiment.

FIG. 21 are optical images showing the overall core-shell assembly in an embodiment.

FIG. 22 are cross-section of freeze-cast scaffolds perpendicular to the freezing direction showing the high degree of alignment of the platelets in the composite walls in an embodiment.

FIG. 23A is a schematic showing the hypothesized platelet alignment during directional solidification in an embodiment.

FIG. 23B is a focused ion beam cut through an individual lamella showing the high degree of alignment of the platelets and the nacre-like arrangement within the composite walls in an embodiment.

FIG. 23C is a plot of toughness obtained with the different scaffold types plotted against the achieved Young's modulus in an embodiment.

FIG. 24 is a typical stress/strain curve of the investigated hybrid scaffolds. Young's modulus was determined from the initial linear region of the curve while the yield strength was taken as the stress at which the material left the linear region and the slope of the curve changed significantly. Toughness was determined as the area under the stress-strain curve up to a strain of 60% in an embodiment.

FIG. 25 is an X-ray microtomography data visualized with the Avizo Standard software package. Edge length of the cube is 500 μm in an embodiment.

FIG. 26 are UV-Vis-NIR reflectance spectra with various fillers from 250 nm to 2500 nm in an embodiment.

FIG. 27A is a SEM image of a broken strut showing encapsulated hollow glass microspheres at 1600× magnification in an embodiment.

FIG. 27B is a SEM image of a glass sphere encapsulated in chitosan polymer, image is shown at 15170× magnification in an embodiment.

FIG. 28 is a plot of Log Avg. Yield Strength vs. Log Avg. Modulus in an embodiment.

FIG. 29 is a SEM image of a polymer scaffold in an embodiment.

FIG. 30 illustrates longitudinal view and traverse view of a scaffold in an embodiment.

FIG. 31 illustrates stress vs strain curves for nanocellulose reinforced composites in an embodiment.

FIG. 32 illustrates yield strength vs modulus curves for nanocellulose reinforced composites in an embodiment.

FIG. 33 illustrates yield strength vs modulus curves for nanocellulose reinforced composites in an embodiment.

FIG. 34 are SEM images of nanocellulose reinforced composites in an embodiment.

FIG. 35 illustrates yield strength vs modulus curves for nanocellulose reinforced composites in an embodiment.

FIG. 36 illustrates stress vs strain curves for nanocellulose reinforced composites in an embodiment.

FIG. 37 illustrates six thermal couples for measuring temperatures during freeze casting in an embodiment.

FIG. 38 illustrates CAS and CAP samples CAP in an embodiment.

FIG. 39 shows a sintering cycle for CAS and CAP in an embodiment.

### DETAILED DESCRIPTION

The present disclosure may be understood by reference to the following detailed description, taken in conjunction with the drawings as briefly described below. It is noted that, for purposes of illustrative clarity, certain elements in the drawings may not be drawn to scale.

Stainless Steel Scaffolds by Freeze Casting for Biomedical Applications

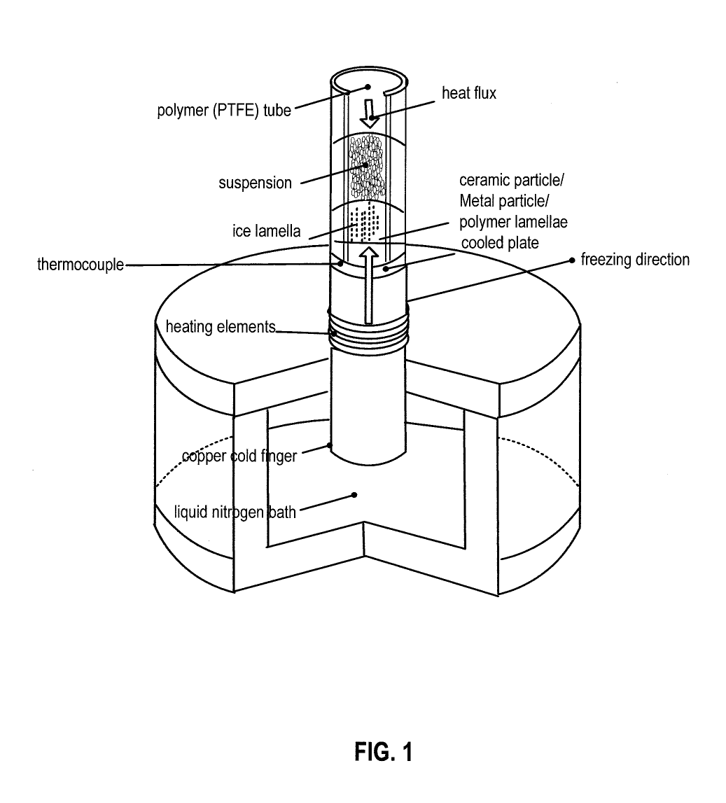

Freeze casting is a processing technique that is based on the unidirectional freezing of a liquid carrier, either within a polymer solution or with particles (metal or ceramic) in suspension. In the past, literature has shown that commonly the freezing vehicle for freeze casting is water, although other carriers, such as camphene. Camphene is an attractive freezing vehicle because it has a freezing temperature of about 33° C., allowing the camphene slurries to surely be frozen at room temperature. It was found that by using water as opposed to camphene, unidirectional freezing could be carried out with greater control in our laboratory. The set up of the freeze casting device is shown in FIG. 1.

Slurry was prepared. The freeze casting process begins with the preparation of an aqueous slurry. Though primarily water, the slurry also consists of a polymer solution, metal particles, or ceramic particles. A binder material is used to provide additional strength to the green body freeze cast sample prior to sintering. Frequently, a dispersant is added to enhance particle dispersion within the slurry. The slurry is thoroughly mixed so that the particles are evenly dispersed throughout. It is usually also degassed directly before freezing and then it is transferred into an insulating polytetrafluoroethylene (PTFE) cylindrical mold with a conductive bottom. For freezing, the mold is placed onto a copper cold finger that is submerged in a bath of liquid nitrogen. This creates a thermal gradient in the axial direction of the sample. As the sample begins to freeze where it is in contact with the cold finger, ice crystals form on the bottom plate of the mold. Upon freezing, water diffuses out of the slurry and causes the ice crystals to grow. As the ice crystals form, the particles within the slurry are either accumulated between the ice crystals or pushed ahead by them or trapped within them, forming particle bridges between particle lamellae.

Sedimentation was followed. Since freeze casting initially involves an aqueous fluid with particles in suspension, the effects of particle sedimentation must be considered. A significant amount of particle sedimentation would result in a scaffold with an inhomogeneous structure with a density gradient, which could lead to inconsistent mechanical properties throughout the material. The rate of sedimentation is a function of the densities of the particle and its fluid carrier, the size of the particles, and the viscosity of the fluid. To calculate a particle's sedimentation velocity, Archimedes' principle and Stokes' law are applied.

When a slurry is ready to begin the freezing process, it is poured into a PTFE mold. This mold is placed onto a copper rod that is submerged in a liquid nitrogen bath. The cooling rate of the copper cold finger is controlled by a ring heater around the copper rod and a thermocouple below the mold. The sample is frozen from the bottom to the top.

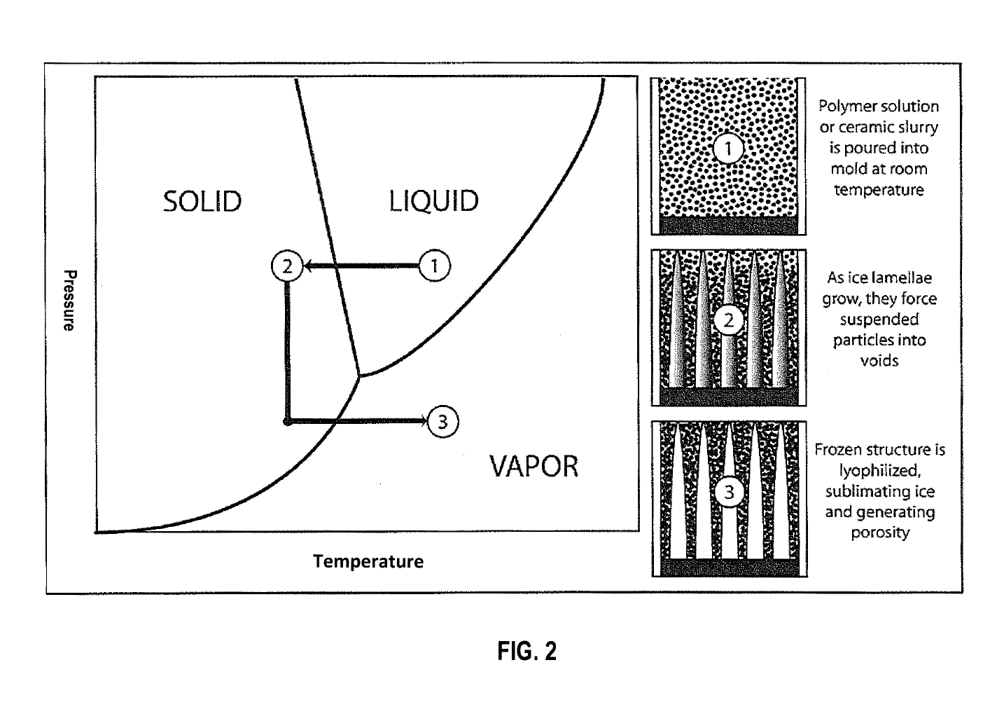

Once the sample is completely frozen, it is removed from the mold in which it was frozen and lyophilized (freeze dried). Initially, in the freeze casting process, the sample is in liquid form. From this state, the sample is directionally frozen. After freezing, the sample is lyophilized. These phase transitions are shown in FIG. 2. During the lyophilzation process, the ice lamellae transition directly from the solid to the gaseous phase as the sample is put under low pressure vacuum while frozen. Once the ice is removed and the sample is entirely dried, a porous scaffold with aligned elongated pores remains.

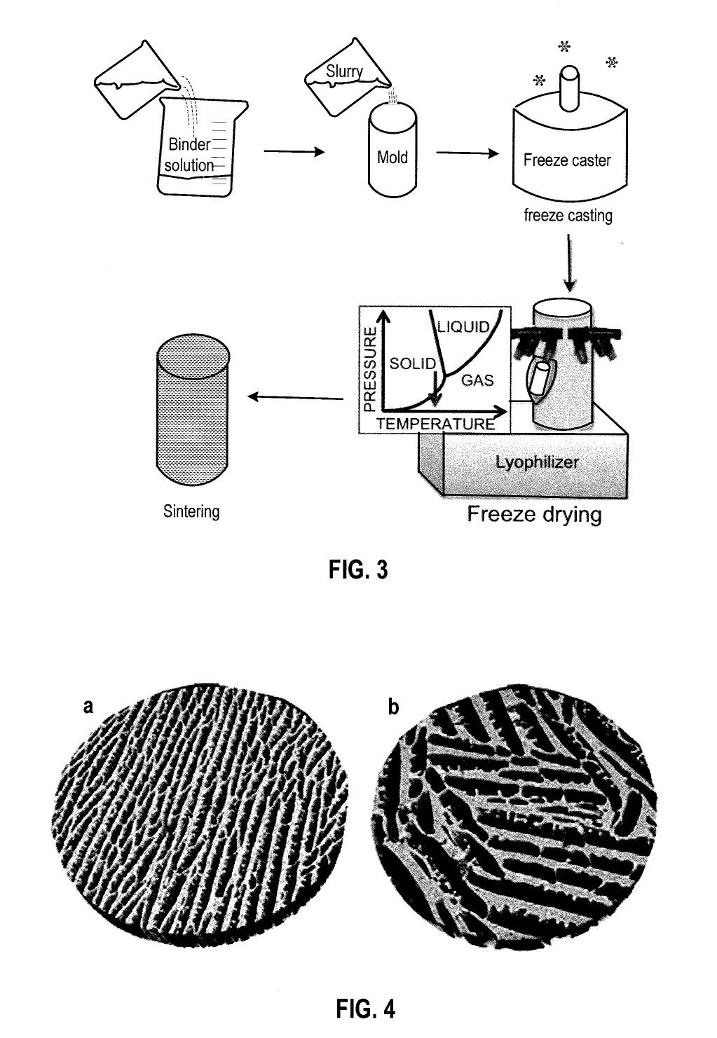

Following freeze drying, a porous scaffold remains with the desired elongated, aligned pore structure within the sample. At this point, the sample is still in its green body form and remains to be sintered. This is the final step of the freeze casting process, summarized in FIG. 3. Sintering is commonly a part of powder processing where a green body is heated to approximately ⅘ its melting temperature so that its particles fuse together.

Sintering greatly increases the mechanical properties of ceramic and metal freeze-cast samples. These properties are, in this case, influenced by the cell wall material properties and the cell wall and foam or honey-comb microstructure acquired after sintering. However, a full analysis on the various effects of processing parameters of sintering is beyond the scope of this thesis. Therefore, some effects will be summarized based upon the studies found in the literature conducted on the sintering of freeze-cast materials. Typically, during sintering, the lamellae within the freeze-cast scaffold, which are composed of a packing of fine particles and fine pores, will undergo densification and grain growth. The extent of densification and grain growth is controlled by the rate of heating during sintering, the sintering time, and the final sintering temperature. As far as mechanical properties are concerned, densification of metals is correlated with an increase in strength and an increase in grain size is linked to a decrease in strength and an increase in ductility.

Sintering can be carried out in two different ways: with pressure and without pressure. Sintering under pressure is mainly done to achieve greater densification. However, freeze cast samples are sintered without applying any pressure to preserve the deliberate aligned porosity produced within the sample. Upon sintering it is expected that the particles fuse together so that densification occurs within the lamellae. On the other hand, it is anticipated that little change occurs regarding densification within the aligned, elongated pores. This is due to the fact that the pore widths are significantly larger than the size of the particles.

During the sintering process it is critical to completely burn off the organic binder prior to reaching the stage where the particles begin to fuse together. Binder removal can be achieved by heating the sample at a low temperature that is just high enough to burn off the binder. Another method is to use a low heating ramp rate to allow enough time for the binder to slowly burn off before the sintering temperature is reached. If the particles fuse together before the binder is sufficiently removed, pockets can form trapping the binder material within the sample.

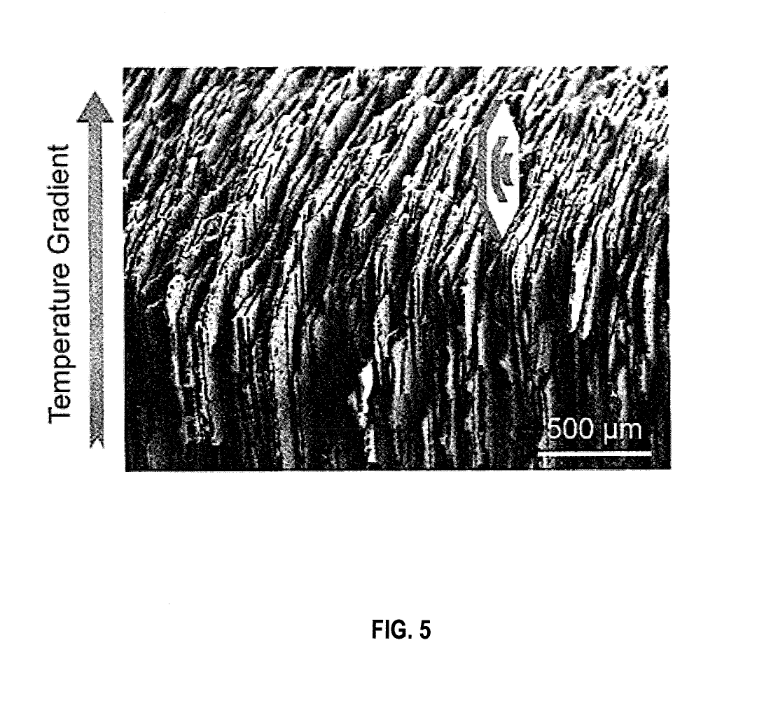

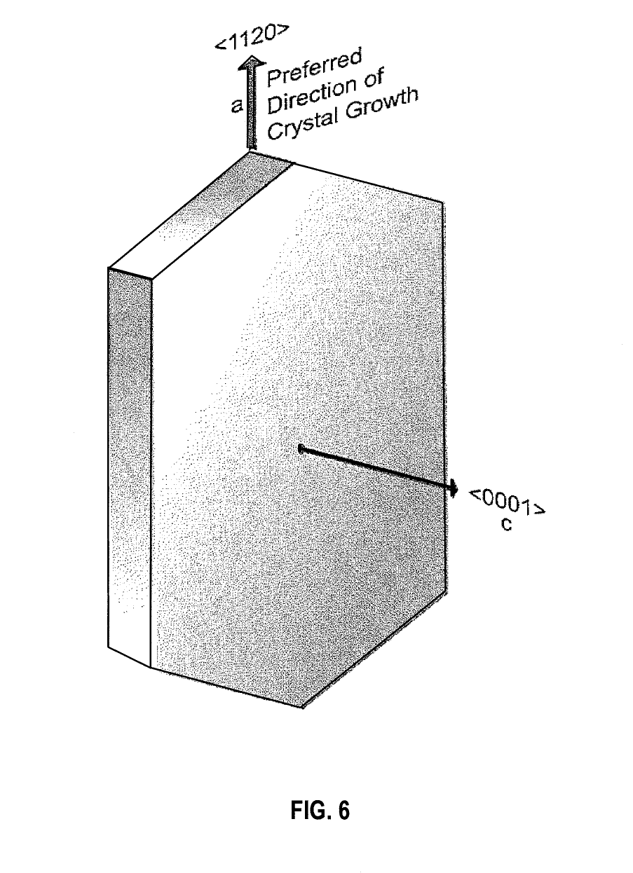

FIG. 4 is an X-ray tomographic reconstructions of a freeze cast ceramic composite sample with a diameter of 0.6 mm. Freezing rate: 20 C/min (a) and 5 C/min (b) in an embodiment. FIG. 5 is a SEM image illustrating anisotropic growth of lamellar ice in an embodiment. FIG. 6 is a simplified diagram illustrating lamellar crystals with their c-axis (<0001>) growing along a-axis (<1120>) in an embodiment.

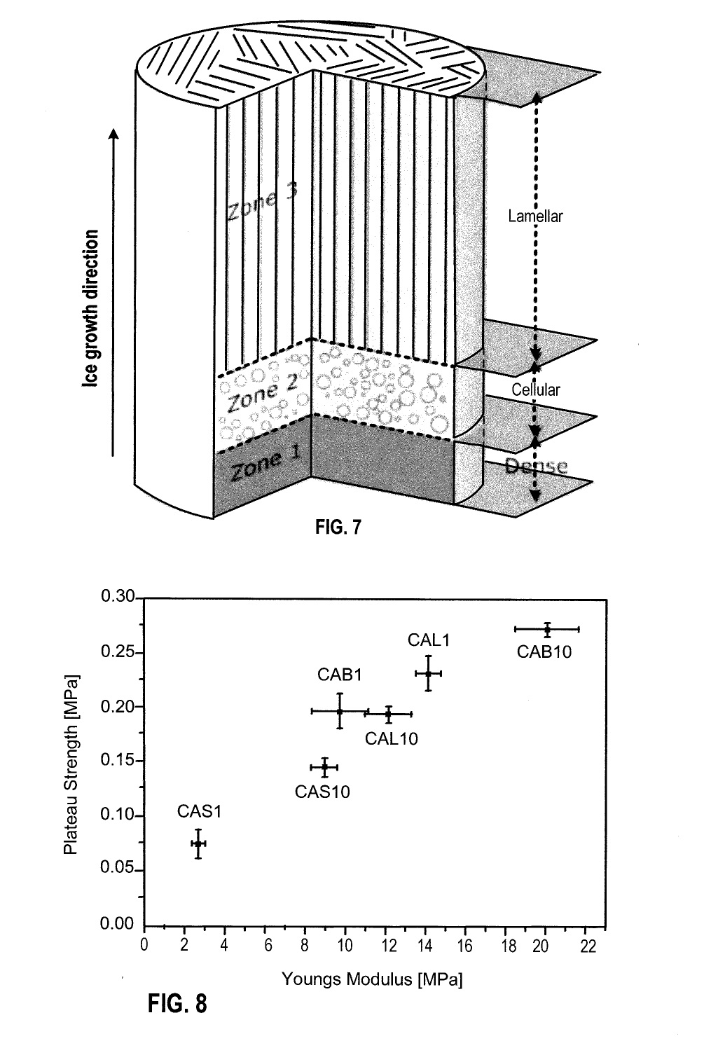

When studying the morphology of a freeze-cast sample, three distinct regions of different microstructures can be identified (FIG. 7). The three zones are characterized by the shape and dimensions of their pores. These different pore regions can be described as dense, cellular, and lamellar, respectively. Zone 1 is the region that is closest to the cold finger. It is a dense zone with no porosity. Located above this dense region is a transition into Zone 2, which is characterized by its closed cellular porosity. In Zone 3, another transition occurs where a lamellar microstructure is achieved. This region, the main area of interest, consists of elongated pores, aligned parallel to the freezing direction.

Faster freezing rates result in smaller lamellar thickness and slower freezing rates increase lamellar width. This is because higher freezing front velocities cause the ice lamellae to grow faster in the direction of the thermal gradient, restricting the growth of lamellae in the direction parallel to the freezing front and resulting in thinner lamellae.

The following materials were used, including 316L stainless steel powder, d₅₀=3 μm (EpsonAtmixCorporation, Hachinohe, Japan), low molecular weight chitosan powder, stored at 6° C. (Sigma-Aldrich, St. Louis, Mo.), Bioreagent Type B gelatin powder (Sigma-Aldrich, St. Louis, Mo.) and Glacial acetic acid (VWR International, West Chester, Pa.).

Polymer solution was prepared. The polymer solution used to suspend the metal particles consisted of a combination of chitosan and gelatin dissolved in 1% acetic acid. It was found that chitosan offered a higher viscosity to suspend the particles in when compared to gelatin. However, it was shown that the addition of gelatin allowed for better mechanical properties in the sample's green body form after lyophilization. Furthermore, it was found that the combination of chitosan and gelatin in the 63/37 wt % ratio resulted in the most homogenous final geometry after freeze drying of the various chitosan-gelatin ratios (50/50, 25/75, 75/25, 63/37 wt %) that were tested.

To prepare the solution, 2.4 g of low molecular weight chitosan powder was weighed out on a high precision balance (±0.01 mg, XP105 Delta Range, Mettler Toledo Inc., Columbus, Ohio) and then transferred in a jar with 100 ml of 1 vol % acetic acid to produce a 2.4% (weight/volume or w/v) chitosan solution. This was mixed on a Wheaton bench top roller apparatus with a rotational speed of 10 rpm for a minimum of 24 hours to ensure that the chitosan powder was completely dissolved and mixed into the acetic acid. To make the gelatin portion of the solution, 5.5 g of gelatin powder were weighed out and transferred into a beaker with 100 ml of 1 vol % acetic acid to produce a 5.5% (w/v) gelatin solution. A PTFE coated magnetic stir bar was inserted into the mixture and it was stirred on a hot plate stirrer at 60 rpm for 12 hours at a temperature of 35° C.

Slurries were prepared by mixing together constituents according to Table 1A. Once all of the components of the slurry were measured and transferred into a mixing cup, the slurry was mixed and degassed in a high shear SpeedMixer (DAC 150 FVZ-K, FlackTek, Landrum, S.C.) at a speed of 2000 rpm for 60 seconds.

TABLE 1A
Various slurry formulations

| | | 2.4% Chitosan | 5.5% Gelatin | |
|---|---|---|---|---|
| Sample | TiH2/316L SS | solution | solution | Ethanol |
| S5 | 5 vol % | 76 vol % | 19 vol % | |
| S10 | 10 vol % | 72 vol % | 18 vol % | |
| S10E | 10 vol % | 64.8 vol % | 16.2 vol % | 9 vol % |
| S30 | 30 vol % | 56 vol % | 14 vol % | |

Since there was a significant difference in the densities of the particles and polymer solution, it was expected that sedimentation would occur. The effects of sedimentation could cause a gradient in the composition, resulting in different mechanical properties along the height of the sample.

Following the freezing process, the sample was freeze dried. The completely frozen sample was first removed from the copper cold finger by hand and then demolded using an arbor press with a wooden punch. The sample was then transferred to a FreeZone 4.5 Liter Benchtop Freeze Dry System (Labconco, Kansas City, Mo.), where it was held at room temperature and at 0.180 mBar for at least 48 hours for the ice phase to sublime.

Sintering temperatures were at 1100° C., 1150° C., and 1175° C. It was determined that 1150° C. was an adequate temperature for the sintering of the 316L stainless steel scaffolds. The process began at room temperature and then the temperature rose at a rate of 5° C./minute until it reached 400° C., where it was held for two hours. During this time, the samples were held in a vacuum of 10⁻⁶ torr to remove all of the organic binder material. After this step, the temperature was increased, at a ramp rate of 7° C./minute, to the sintering temperature of 1150° C., where it was held for two hours before it was returned to room temperature at the same rate. During this stage, at which sintering occurred, the samples were removed from vacuum and subjected to a reducing atmosphere of argon with 4% hydrogen (Ar about 4% H₂).

Once sintered, the samples were suitably sectioned into different shapes and sizes for mechanical and structural characterization. Samples were mechanically tested to determine the yield strength and Young's modulus of the sample. Additionally, the samples were structurally characterized to evaluate the structure-property correlations.

The sectioned cubes were tested in compression using an MTS 793 material testing system (MTS Systems Corp., Eden Prairie, Minn.) with a 5 kN load cell and a cross head speed of 0.025 mm/s, corresponding to a strain rate of 10⁻³/s. The samples were compressed in the direction parallel to the temperature gradient during freezing. To provide a frictionless surface for the samples, the compression platens were covered in PTFE tape prior to each compression test.

To determine the overall porosity of the freeze-cast sample, the samples were weighed on a high precision balance (±0.01 mg, XP105 Delta Range, Mettler Toledo Inc., Columbus, Ohio) and their dimensions were measured with calipers (±0.02 mm, Series 500 Absolute Digimatic Caliper, Mitutoyo America Corp, Aurora, Ill.) prior to sectioning.

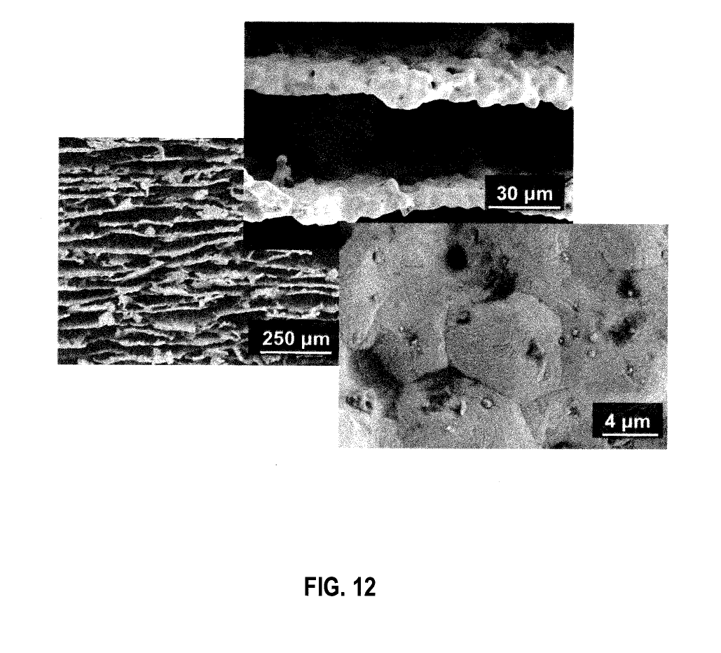

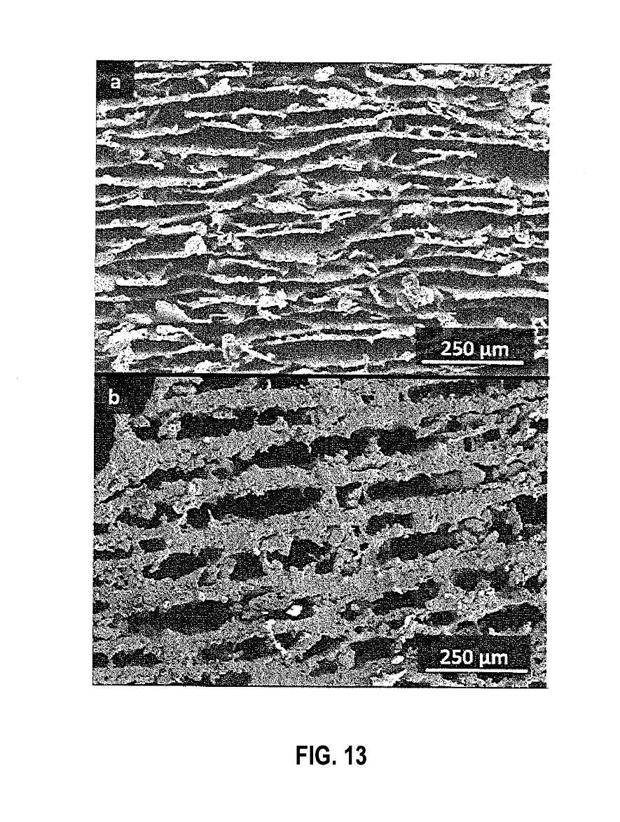

The microstructure was analyzed using SEM images taken with a Zeiss Supra 50VP, (Carl Zeiss SMT Inc., Peabody, Mass., USA) at accelerating voltages between 2 and 10 kV. To determine pore dimensions and wall thicknesses, imaging software (ImageJ, U.S. National Institutes of Health, Bethesda, Md.) was used to take measurements and to calculate mean values and standard deviations. FIGS. 12A-C are three SEM images of 316L stainless steel scaffolds from the third sintering trial at 1150° C. in an embodiment. FIGS. 13A-B illustrate two SEM images of cross sections (perpendicular to the freezing direction) from samples S10 (a) and S10E (b) in an embodiment.

Further microstructural analysis was carried out by X-ray tomography using a high resolution micro-computed tomography scanner (SkyScan1172, Kontich, Belgium). Samples (1 mm cubes) of different compositions were scanned with a nominal pixel resolution of 0.7 μm. Each scan was reconstructed using SkyScan's volumetric reconstruction software, nRecon. The acquired and reconstructed dataset of .tif image stacks was visualized 3-dimensionally using VGStudio Max image analysis software (VGStudio Max 2.0, Volume Graphics GmbH, Heidelberg, Germany).

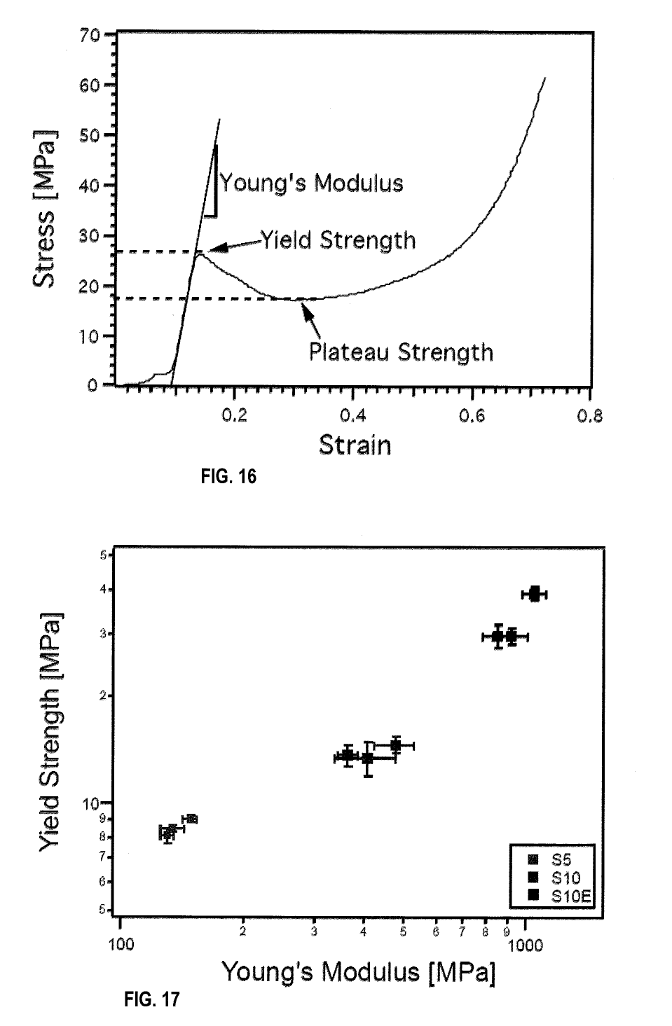

To determine mechanical properties of the freeze-cast stainless steel in dependence of their composition, freeze-cast samples of three different compositions S5, S10, and S10E (all frozen at 1° C./minute) were tested in compression. From the stress-strain curves, Young's modulus, yield strength, and plateau strength were determined. A typical stress-strain curve for a sample is shown in FIG. 16, indicating how the mechanical properties were determined.

The mechanical properties of the three samples are listed in Table 1B. Relative density is density of the porous material divided by the density of the solid from which it is made. For example, stainless steel foam has a 80% porosity which translates to a relative density of 0.8.

Porosity=1−(relative desity)=1−[(density of cellular solid)/(density from which cellular solid is made)]. It was found, as expected, that the sample (S5), with the lowest relative density of 0.168 and the lowest amount of steel loading (5 vol %), had both the lowest Young's modulus and yield strength, with 137±13.6 MPa and 8±0.5 MPa, respectively. Surprisingly, samples S10 and S10E, with the same amount of steel loading (10 vol %), showed greatly differing mechanical properties. Comparing sample S10 to S10E, values ranged from 415±96.8 to 941±147 MPa for Young's modulus, and 14±2.1 to 32±3.5 MPa for yield strength.

TABLE 1B
Mechanical properties of 316L stainless steel scaffolds

| | | Young's | Yield | Plateau |
|---|---|---|---|---|
| | Relative | modulus | strength | strength |
| Sample | density | [MPa] | [MPa] | [MPa] |
| S5 | 0.168 ± 0.007 | 137.42 ± 13.58 | 8.58 ± 0.51 | 8.58 ± 0.51 |
| S10 | 0.215 ± 0.005 | 415.13 ± 96.75 | 13.94 ± 2.10 | 10.68 ± 1.74 |
| S10E | 0.281 ± 0.012 | 941.38 ± 147.51 | 32.77 ± 3.45 | 19.47 ± 4.03 |

In FIG. 17, yield strength is plotted against Young's modulus. It is shown that by increasing the steel content from 5 vol % (S5) to 10 vol % (S10), higher mechanical properties can be achieved. However, this increase in solid loading was not necessary to achieve higher mechanical properties when analyzing samples S 10 and S10E. With an identical amount of stainless steel loading and identical processing conditions, sample S10E was almost twice as strong and over twice as stiff as sample S10. The reason for this may partially be because sample S10E had a higher relative density, but further explanation was left to be determined by microstructural analysis.

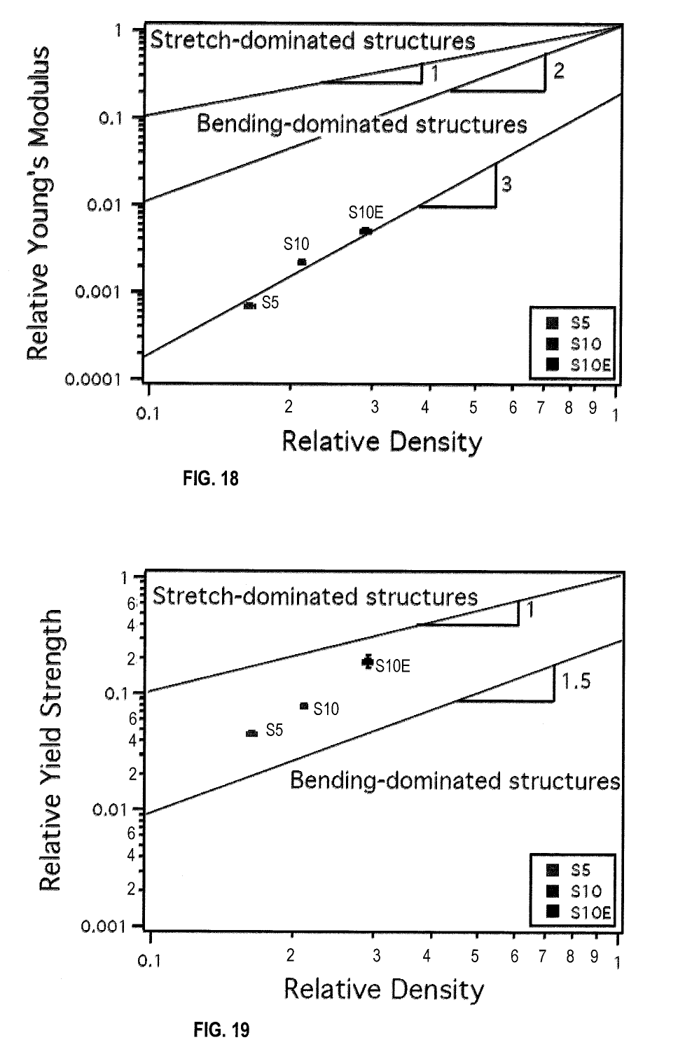

FIG. 18 shows a plot of relative Young's modulus versus relative density. Once more, the different slopes in this graph correspond to the two different deformation behaviors in cellular materials. It can be seen that all of the samples fall significantly below the values predicted by theory.

To further analyze the mechanical behavior of the three samples, graphs of relative yield strength (strength of scaffold/strength of bulk material) and relative Young's modulus (modulus of scaffold/modulus of bulk material) versus relative density (density of scaffold/density of bulk material) were plotted. In FIG. 19, a line of slope 1 indicates honey-comb-like stretch dominated behavior, whereas a line of slope 1.5 indicates foam-like, bending-dominated behavior. All three samples fall well above the line representing bending-dominated structures, meaning that they all perform better in strength than an ideal foam-like material. Sample S10E falls closest to the line indicating stretch-dominated structures, showing that it deforms more like an ideal honey-comb-like structure.

To gain a better understanding as to why two samples, which were processed under the same conditions and had equal amounts of steel loading, would have such different properties, their microstructures must be investigated. SEM and x-ray microtomography (μCT) was used to evaluate why sample S10E is over twice as stiff and almost twice as strong as sample S10.

SEM images of the samples revealed a large difference in pore structure between samples S 10 and S10E. Pore sizes and cell wall thickness were measured, from SEM micrographs, as indicated in FIG. 14, revealing that with a thickness of 9±2 μm the cell walls of S10 are about seven times thinner than those of S10E, which are 60±9 μm thick. Furthermore, it was found that S10 had an average lamellar spacing or short pore axis of 34±8 μm, which is almost half of 69±8 μm, the value for S10E.

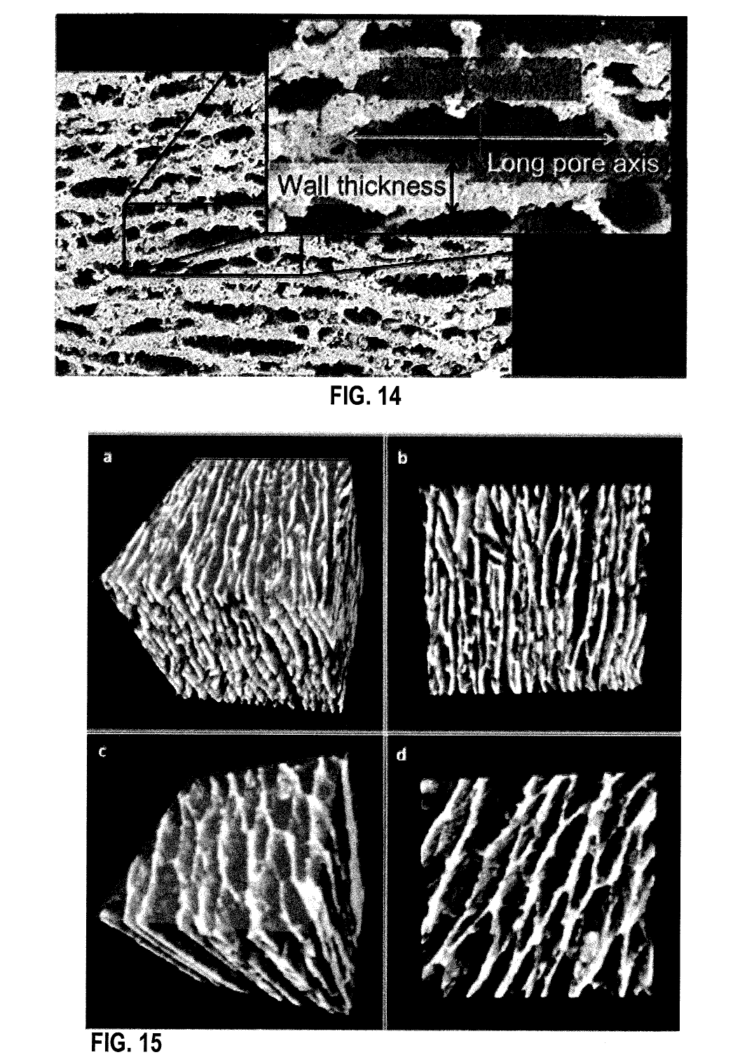

FIGS. 15 a-d show four tomographic reconstructions of samples S10 (a, b) and S10E (c, d). Images a and c show a full 3-D reconstruction of the samples. The colored planes on the cubes show a cross section perpendicular to the scaffold's freezing direction. Images b and d show these cross sections in 2D. The cubes and cross sections had 1 mm side lengths. FIGS. 15b and d show cross sections, perpendicular to the freezing direction, of samples S10 and S10E, respectively. It is shown that the lamellar spacings and wall thicknesses in sample S10 are significantly less than those of sample S10E.

It was shown that through the process of freeze casting, a highly porous metal scaffold could be produced with tailored features. By modifying the ratio of metal particles to polymer solution in the initial slurry, the overall porosity or relative density could be altered. Sample S 10 was created using a slurry similar to the one used in sample S5. To produce sample S10, an increased amount of stainless steel powder was used (10 vol %), double the volume used in sample S5 (5 vol %). By increasing the solid loading in the slurry, an increase in relative density, from 0.168 to 0.215, was observed in the sintered samples S5 and S10, respectively. With the freeze casting process, it was shown that greater cell wall thicknesses and pore sizes could be achieved with a slower cooling rate, demonstrating that pore sizes could be controlled by varying the rate at which a sample is frozen. When the cooling rate was reduced during the freezing process, additional time was granted for ice crystal growth in the direction perpendicular to the freezing direction, which resulted in an increased pore size, which also corresponded to an increased wall thickness.

Similarly, by introducing different additives, such as ethanol, into the slurry, pore morphology within the final freeze cast sample could be altered. Samples S10 and S10E were frozen with identical amounts of stainless steel content (both 10 vol %) and at the same cooling rate (1° C./minute). However, 9 vol % of the polymer solution used to produce sample S10E was replaced by ethanol, as opposed to the polymer solution used to make sample S10, which consisted only of chitosan and gelatin in lvol % acetic acid. A significant increase in pore size and wall thickness was observed in sample S10E with the addition of ethanol in its polymer solution. Wall thicknesses in sample S10 was measured to be, on average, 9 μm, which is about seven times thinner when compared to the average wall thickness of 60 μm as measured in sample S10E. Furthermore, the average lamellae spacing, or short pore axis, in sample S10E was observed to be 69 μm, which was about twice the spacing observed in sample S10.

It was previously mentioned that a sample's relative density could be altered by adjusting the ratio of solid to liquid content in the slurry. Through experimentation, it was found that the relative density could also be altered with the sintering process. This is illustrated with samples S10 and S10E. Prior to sintering, they had equal relative densities, based on their equal volumes of solid loading. After sintering under identical conditions, sample S10 had a relative density of 0.215 and sample S10E had an over 30% greater relative density of 0.281. This indicated that sample S10E experienced greater densification during sintering. The greater densification in the case of S10E is probably due to the larger amount of porosity in the cell walls prior to sintering, which was observed on SEM micrographs. In sample S10, the thickness of the cell walls was limited to only about one to three particles, in contrast the cell walls of sample S10E were closer to 20 particles thick and composed of randomly packed particles of varying size resulting in greater porosity within the cell walls. During sintering, sample S10E experienced a greater shrinkage in cell wall dimensions, which also leads to a greater reduction in pore size when compared to sample S10, resulting in a greater relative density after sintering. It was further shown, during the various sintering trials conducted in this study, that the relative density of a sample could be also be altered by sintering at different temperatures. When the sintering temperature was raised from 1100° C. to 1150° C., samples S10 and S10E both experienced an increase in relative density of 21.5 and 15.2%, respectively. In general, sintering at a higher temperature resulted in greater densification within the cell walls, greater cell wall material shrinkage and thus pore size reduction, thereby increasing the overall relative density of the material.

From optical microscopy images, SEM images, and 3-dimensional tomographic reconstructions, the microstructures within samples S10 and S10E were studied. As previously mentioned, samples S10 and S10E were frozen with the same amount of stainless steel loading and processed under the same parameters. The only alteration was that a 9 vol % of ethanol was incorporated into the polymer solution used to make sample S10E. This distinction was responsible for the drastic differences in microstructure between samples S10 and S10E. As discussed in the earlier section, when compared to sample S10, sample S10E had a greater lamellae spacing and cell wall thickness. It was presumed that this was because the addition of ethanol into the polymer solution effectively lowered the freezing temperature of the slurry, therefore, altering the kinetics of the freezing process, the details of which are, at present, not entirely understood.

During structural analysis, in addition to wall thickness and lamellae spacing, the average aspect ratio of the pores within samples S10 and S10E were measured and found to be 8.8 μm and5.5 μm, respectively. In FIGS. 14 and 15, it can clearly be seen that sample S10 had a much larger aspect ratio than sample S10E. This variation in aspect ratios strongly contributed to the differences noted in mechanical properties, as detailed below. Another reason for sample S10E achieving higher properties in yield strength and Young's modulus, it thought to be due to its smaller pore aspect ratio, resembling a honey-comb structure, which has higher mechanical properties than an equiaxed, bending-deformation dominated foam because of its stretch-dominated deformation behavior.

Stainless steel freeze-cast scaffolds as bone implant material: It was mentioned in an earlier section that according to the literature, bone scaffold material should have at least 50% open porosity to promote tissue in growth, along with interconnected, aligned pores with a mean diameter of 100-400 μm. Furthermore, since the scaffold will be used for a load bearing application, it must be able to support physiological loads. In this study, the samples produced showed great potential as a possible bone implant material. Samples S5, S10, and S10E all fall in the desired property range and well inside the region of cancellous bone. Additionally, all three samples had an overall open porosity of at least 70% or more.

Additionally important was a comparison not only of individual mechanical properties but also of the overall mechanical performance of natural bone with this potential bone substitute material. According to Gibson-Ashby, the properties of cancellous bone depend strongly on relative density and structure. Cancellous bone has a Young's modulus that varies with relative density raised to the power that ranges from 1 to 3, depending on cell shape and orientation. Similarly, the yield and plateau strength vary with relative density to a power that ranges between 1 and 2, depending as the modulus does on the pore structure and orientation. Freeze-cast bone substitute material thus not only parallel the material property values of natural bone but also its mechanical performance, suggesting that it may provide newly forming bone with the appropriate mechanical stimuli to regenerate bone with the desired properties and without the danger of stress shielding.

316L stainless steel scaffolds were produced by freeze casting. With 70% porosity, these scaffolds achieved yield strengths of 32 MPa and Young's moduli of 940 MPa, values that fall into the strength and stiffness range of cancellous bone. The freeze casting process proved to be an ideal technique to produce custom-designed scaffold architectures, achieved simply through the selection of suitable processing parameters and compositional variations, whose mechanical properties can be greatly varied for one given relative density or overall porosity. These stainless steel scaffolds are thought to have great potential in serving as replacement materials for cancellous bone, due to their structure (e.g. overall porosity, pore geometry), mechanical property values (e.g. stiffness, strength, toughness) and overall mechanical performance (e.g. deformation mechanisms).

Structure-Property-Processing Correlations in Freeze-Cast hybrid Materials

Low molecular weight chitosan (75-85% deacetylated, Sigma Aldrich, St. Louis, Mo.) at a concentration of 2.4% (w/v) was dissolved in 1% (v/v) glacial acetic acid (VWR International, West Chester, Pa.) in doubly distilled water. To achieve thorough mixing, the chitosan solution was rolled on a ball roller at 20 rpm for at least 24 hours before it was used.

Gelatin Solutions were prepared by dissolving 5.5% (w/v) gelatin in 1% (v/v) glacial acetic acid (VWR International, West Chester, Pa.) in doubly distilled water. The gelatin solutions were mixed by magnetic stirring at 60 rpm for 12 hours at a temperature of 35° C. prior to their use. Chitosan and gelatin solutions were mixed in a volume ratio of 4:1 in a high shear mixer (SpeedMixer, DAC 150 FVZ-K, FlackTek, Landrum, S.C.) at a speed of 1600 rpm for 60 s to blend a 3% (w/v) polymer solution consisting of 63 wt % chitosan and 37 wt % gelatin.

Slurry preparation was done after the chitosan and gelatin solution was prepared. To obtain ceramic-biopolymer composite solutions, 2.7 g of Al₂O₃ particles were added to 10 mL of polymer solution. In the case of chitosan-gelatin solutions this yielded a solid weight ratio of 9:1 (alumina:biopolymer) and a volume ratio of the dry solid in the lyophilized scaffolds of 75% alumina and 25% biopolymer (16% chitosan, 9% gelatin). Chitosan-gelatin solutions were used for most of the experiments in this study, including the correlation between cooling rate and structural features and the investigation of different particle sizes and shapes.

For the systematic ethanol study, the investigation of different porosities within the scaffolds as well as for the biocompatible hydroxyapatite/chitosan scaffolds, pure chitosan solutions were used. In the final scaffolds, this resulted in a solid weight ratio of 11.25 (alumina to chitosan) which corresponds to a dry solid volume fraction of 77% alumina and 23% chitosan. As alumina fillers, three different types of particles were used: platelets (Alusion™, Antaria Limited, Bentley, Western Australia) thickness: 300-500 nm, diameter: 5-10 μm small spherical particles (Sasol North America-Ceralox Division, Tuscon, Ariz.) average diameter: 400 nm large spherical particles (Sigma Aldrich, St. Louis, Mo.) diameter: 5-10 μm The particle sizes of the spherical alumina particles were chosen to represent the smaller (thickness) and larger dimensions (diameter) of the alumina platelets used in this study. For the biocompatible hydroxyapatite/chitosan scaffolds, hydroxyapatite powder of spherical particles with an average particle diameter of 2.3 μm was used (Trans-Tech, Inc., Adamstown, Md.). Directly before freeze casting, the suspensions were mixed and degassed in a shear mixer (SpeedMixer, DAC 150 FVZ-K, FlackTek, Landrum, S.C.) at a speed of 1600 rpm for 60 s.

Freeze casting ceramic-polymer slurries (12 mL) were pipetted into freezing molds directly before freeze casting. The molds were placed on the cold finger of the freeze casting apparatus and allowed to adjust their temperature to 5° C. which was the starting temperature of the cold finger. Through the use of the PID controller, the thermocouple and the band heater, the temperature of the upper cold finger surface was decreased according to predefined cooling programs. Two different cooling rates were applied: 1° C./min and 10° C./min. As the temperature of the cold finger was lowered below 0° C., ice nucleation started at the bottom plate of the mold and the slurries were directionally solidified from bottom to top. For both cooling rates, the temperature was decreased until a final freezing temperature of −80° C. was reached. The molds were held at this temperature until the complete sample was solidified.

Freeze drying was performed after freeze casting. The frozen samples were unmolded with a modified arbor press and transferred to a benchtop lyophilizer (FreeZone 4.5, Labconco, Kansas City, Mo.) where they were freeze-dried (lyophilized) for at least 48 hours. The pressure within the system was 0.02 mBar and the cold trap was set to a temperature of −50° C. The obtained scaffolds had a cylindrical shape with a diameter of 18 mm and a height of 35 mm. After lyophilization, the scaffolds had an average porosity of 91%.

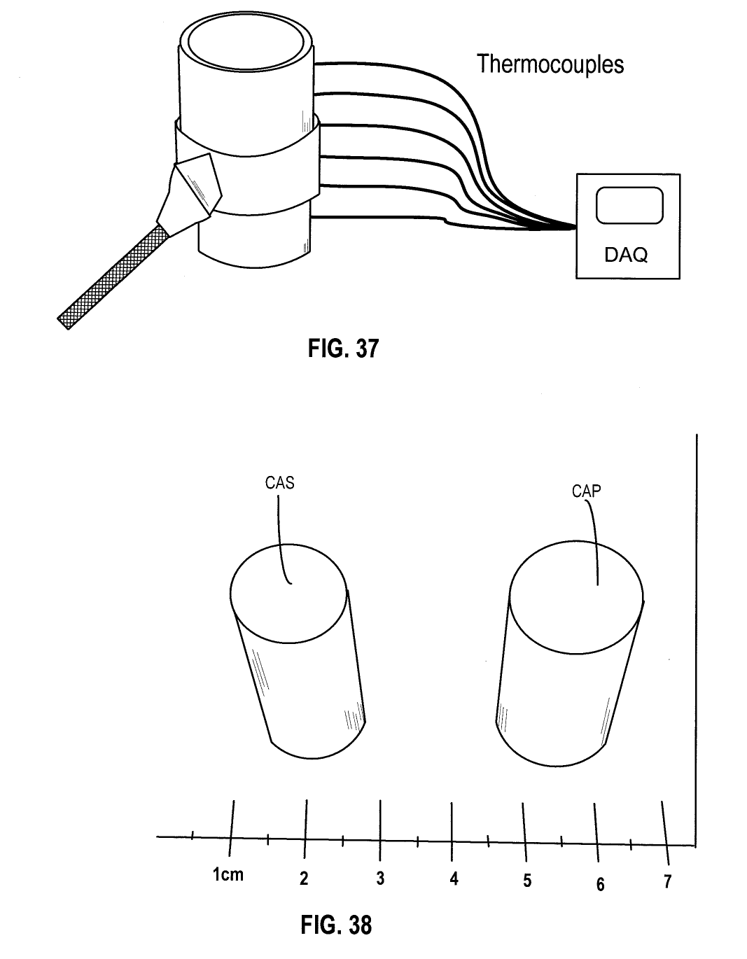

Custom-made thermocouple mold equipped with 6 thermocouples along its height. The thermocouples were connected to a data acquisition unit where the temperatures measured at each thermocouple were recorded over time. Six thermocouples were mounted along the height of a PTFE mold to monitor the temperature profile during freezing (see FIG. 37). For three different alumina powders, the particle self assembly in the honey-comb walls was determined and the pore structure and mechanical properties measured after processing with cooling rates of 1° C./min and 10° C./min which correspond to freezing front velocities of 7.4 μm/s and 27.7 μm/s, respectively.

Sample preparation for characterization and tests is described as follows. To test the effect of different ethanol concentrations on structure and properties, slurries of alumina platelets in chitosan solutions were prepared. All samples included the same amount of ceramic filler but different amounts of ethanol. In addition to a control with 0% ethanol, the four ethanol concentrations 5, 10, 15 and 20% (v/v) were studied. All slurries were freeze-cast at a cooling rate of 10°/min. After lyophilization, the scaffolds possessed an overall porosity of 91.3±0.6%.

For X-ray microtomography, rectangular samples of 5 mm×5 mm and a thickness of 2 mm were cut with a diamond wire saw so that the 2 mm dimension was oriented parallel to the freezing direction. For tomography, the sample was mounted upright on a cylindrical metal holder and placed in a SkyS can 1172 high-resolution desktop micro-computed tomography system (SkyScan, Kontich, Belgium). Radiographs were taken at a voltage of 59 kV, a current of 167 μA and a pixel size of 1.47 μm. An exposure time of 2356 ms and a frame averaging of 5 was used. The rotational step size was 0.15°, thus 1200 angles were used for reconstruction. This tomographic reconstruction was performed with the SkyScan software NRecon.

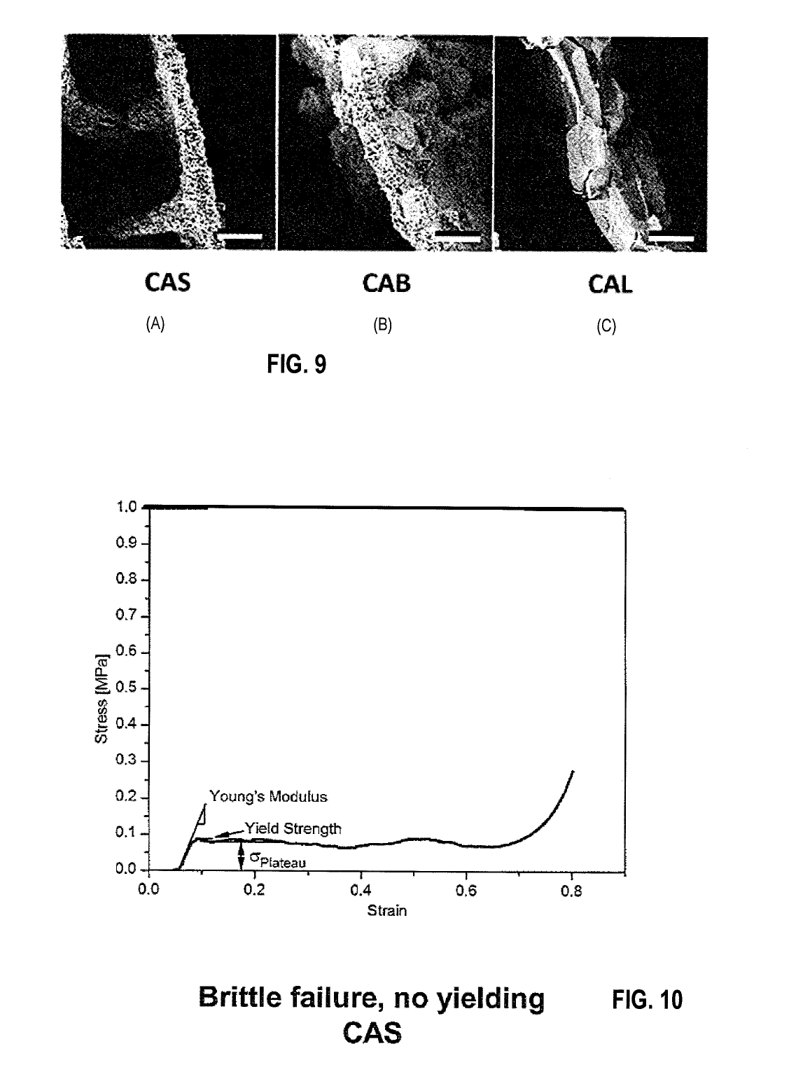

FIGS. 9A-C are SEM micrographs of composite cell walls of hybrid scaffolds made from a) small particles b) bimodal particles c) large particles. Scale bar is 5 μm. The SEM micrographs of the three different scaffold types reveal significant differences in the wall architecture.

The size of the small particles is much smaller than the wall thickness and the particles are thus incorporated into the wall structure, glued together by the polymeric matrix (see Table 2). Between 5 and 15 layers of particles make up the walls with a thickness of 2 to 7 micrometers. In the case of the large particles, the cell walls consist only one layer of particles. They are incased and interconnected by a polymer membrane. The walls made from the bimodal composition are a combination of the two. The polymer membrane between the large particles includes several layers of small particles and the wall thickness is smaller in comparison to the small particle scaffolds because of the smaller amount of small particles that have to be accommodated within the walls.

TABLE 2
Wall thickness in dependence of the particle size and freezing
rate as determined with scanning electron microscopy.

| | Alumina particle | | Overall porosity | Wall thickness |
|---|---|---|---|---|
| Freezing rate | size | | [%] | [μm] |
| 1° C./min | 400 | nm | 91.4 ± 0.1 | 5.79 ± 1.06 |
| 1° C./min | 30:70 | | 90.8 ± 0.1 | 3.12 ± 0.67 |
| | 400 nm:10 μm | | | |
| 1° C./min | 10 | μm | 90.5 ± 0.2 | 0.55 ± 0.38 |
| 10° C./min | 400 | nm | 91.8 ± 0.1 | 2.79 ± 1.00 |
| 10° C./min | 30:70 | | 90.9 ± 0.1 | 2.09 ± 0.20 |
| | 400 nm:10 μm | | | |
| 10° C./min | 10 | μm | 90.2 ± 0.1 | 0.32 ± 0.06 |

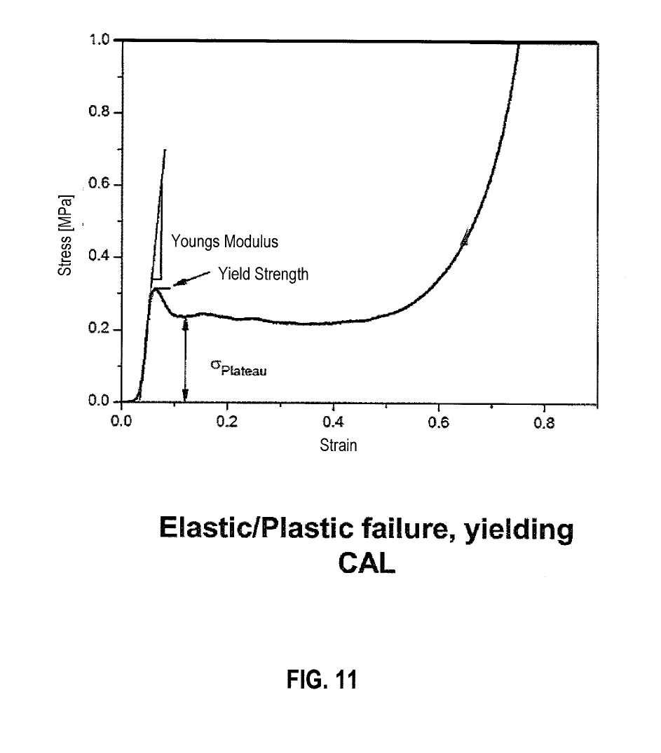

FIG. 10 and FIG. 11 show Young's modulus for scaffolds including different particles sizes and size distributions, frozen at two different freezing rates of 1° C./min and 10° C./min.

The representative compression curves and the SEM images are shown for scaffolds made from a) small particles (FIG. 10) and b) large particles (FIG. 11) respectively. As the microstructure indicates, the small particles and the obtained brick-and-mortar structure result in brittle failure while the large particles and the beads-on-a-string architecture lead to elastic-plastic failure. Scale bar is 5 μm.

Failure modes are shown in FIGS. 10 and 11. Not only the absolute mechanical properties were increased for the larger average particles size, but also the shape of the compression curves was different from those of the other compositions. Scaffolds made from small particles, have a saw-tooth patterned stress-strain curve, typical for brittle cellular solids, while those made from large particles have a smooth plateau region, which is typical for porous scaffolds with an elastic-plastic failure. The scaffolds including the bimodal particles size distribution show a mixed behavior and, depending on the height in the sample and the freezing rate, either have a saw-tooth stress-strain curve or a smooth plateau. Thus, through the variation of the particle size, not only the mechanical properties, but also the failure modes can be controlled. Scaffolds made from small particles fail in a brittle manner, scaffolds made from large particles show elastic-plastic failure.

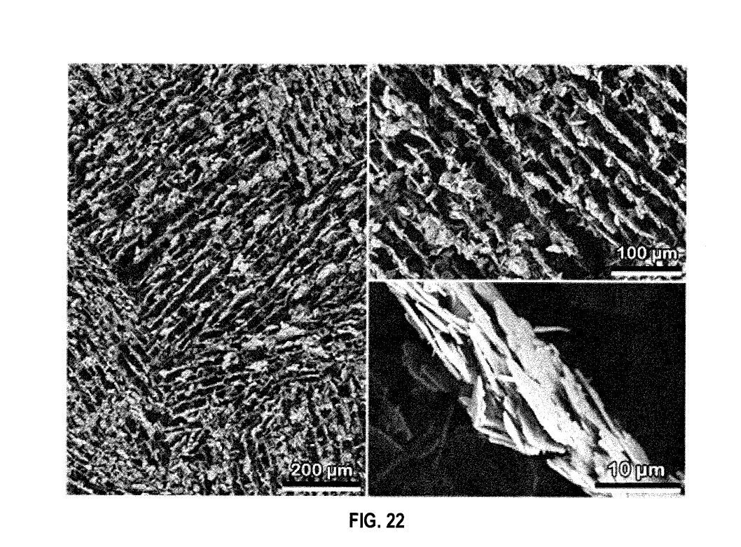

Scaffold structure is shown in FIG. 22: The created freeze-cast scaffolds indeed possessed a lamellar structure with composite walls of highly aligned alumina platelets glued together by the polymeric phase. The lamellar spacing was the same as previously determined for the scaffolds including spherical particles with 28 μM for a freezing rate of 10° C./min and 34 μm for a freezing rate of 1° C./min. In all SEM images, the nacre-like arrangement of the platelets in the walls is evident, however, due to cutting damage, several lamella show rugged edges with platelets or small pieces of the lamellae that were pushed over the interlamellar spaces.

Focused ion beam was used to cut a cross-section for SEM images. While the SEM images of the wire-cut cross-sections showed the general alignment of platelets, the damage of the cut partly obscured the real microstructure of the lamellae. Especially for the lateral dimension of the lamellae and the degree of platelet-alignment within the cell walls, no reliable statements could be made. A non-destructive method like X-ray microtomography would have been desirable at this point but unfortunately does not provide enough resolution to resolve individual platelets. To still be able to investigate the micro-architecture of the lamellae and the arrangement of platelets within the pore walls, a focused ion beam (FIB) system was used to cut a window into a single lamella. The beam current of the FIB (Strata DB235, FEI Company, Hillsboro, Oreg., USA) was set to 50 pA and an accelerating voltage of 30 kV was used.

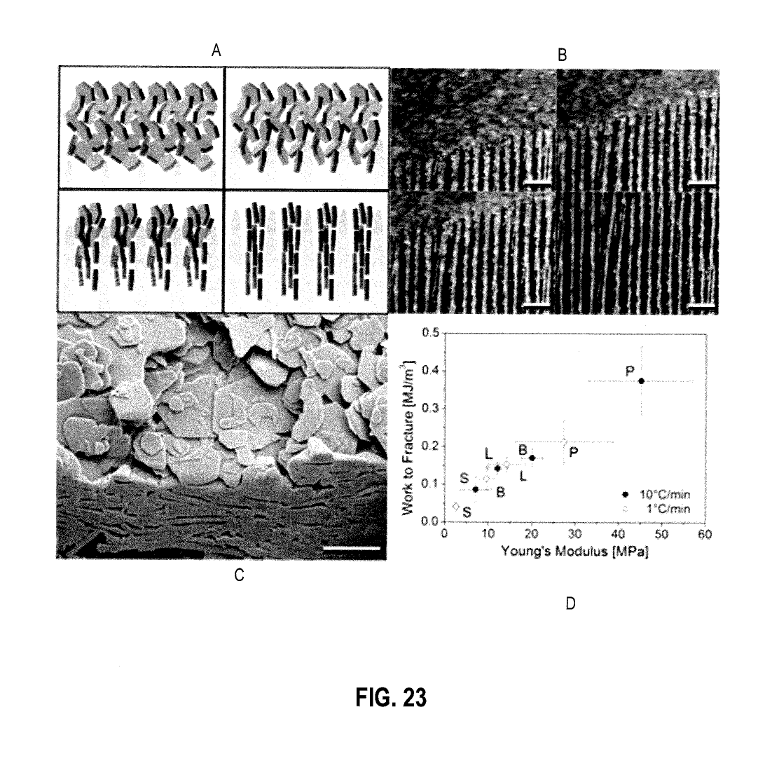

FIG. 23C shows a close-up of the cross-section, revealing the arrangement of platelets and the thickness of the lamella. The platelet-composite walls indeed possess the desired nacre-like arrangement of highly aligned platelets glued together by the polymeric phase. As estimated from the SEM images the wall has a thickness of approximately ten platelets.

FIG. 16 shows typical stress/strain curve of the investigated hybrid scaffolds. Young's modulus was determined from the initial linear region of the curve while the yield strength was taken as the stress at which the material left the linear region and the slope of the curve changed significantly. Toughness was determined as the area under the stress-strain curve up to a strain of 60%.

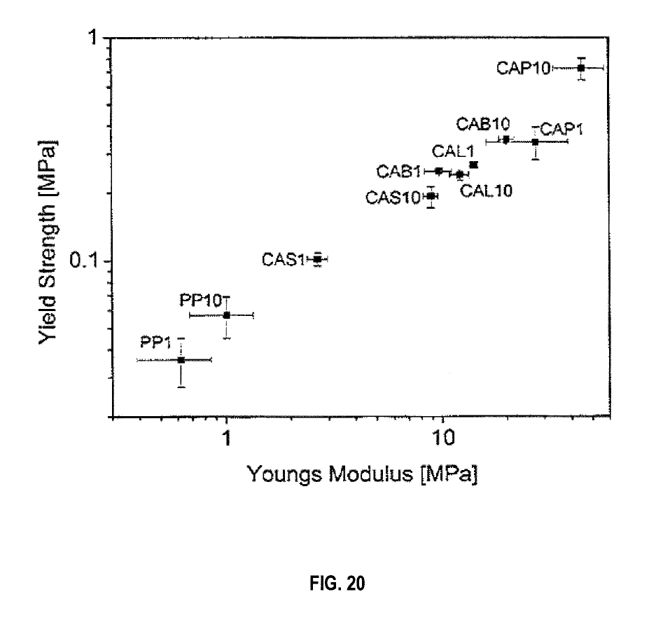

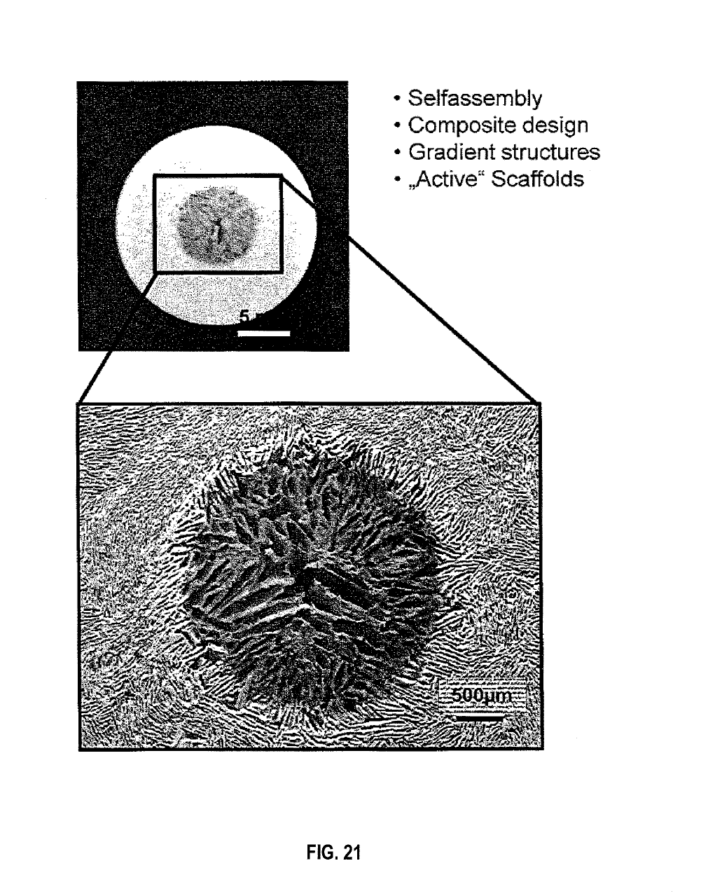

FIG. 20 shows Young's modulus and yield strength for the porous hybrid materials including small, bimodal and large particles as well as platelets. The platelets achieve the highest stiffness and strength while the small particles possess the lowest values.

Films made by drying of slurries with identical composition as those used fro freeze casting showed strong particle adhesion and dense particle packing. However, due to the limited availability of polymeric glue, the different slurry recipes yielded significantly changing particle arrangement both in the 2D films and in the freeze-cast cell walls. Small particles with a diameter below the wall thickness were incorporated into the walls and densly packed in multilayers, resulting in a brick-and-mortar structure. Large particles with a diameter above the wall thickness resulted in pearl-on-a-string arrangement with a single layer of particles within each lamella.

Sedimentation Stoke's law:

$${v}_{s} = \frac{2}{9} \frac{( {ρ}_{P} - {ρ}_{L} )}{μ} g {r}^{2}$$

ρ_{P}: density of particle
ρ_{L}: density of liquid
μ: viscosity of fluid
r: particle radius
g: gravitational acceleration

### Effect of Particle Sizes and Cooling Rates on Mechanical Properties

FIG. 20 illustrates results from compression tests on porous composites. The mechanical properties can be significantly varied through different particle size distributions and freezing rates. Both modulus and strength increase with an increase in the freezing rate for the composites with small (CAS) and bimodal (CAB) particle sizes, but stay constant for large particles (CAL). For both freezing rates, the small powders or particles resulted in the material with the lowest mechanical properties (CAS). At 1° C./min, the composite with the large particles (CAL) achieved both the highest modulus and the highest strength with 14 MPa and 0.23 MPa, respectively. At 10° C./min, the scaffolds with the bimodal particle distribution (CAB) had with 20 MPa and 0.27 MPa the highest respective values. These property differences are due to differences in particle sedimentation speed, freezing front velocity, and, very importantly, the arrangement of particles in the lamellae.

FIG. 8 is a plot of plateau strength against Young's modulus for scaffolds including different particles sizes of particles and size distributions, frozen at two different freezing rates of 1° C./min and 10° C./min in an embodiment.

The experimental results reveal strong structure-property-processing correlations and illustrate that the mechanical properties as well as the structure of freeze-cast hybrid scaffolds can be controlled independently on at least three hierarchical levels. First, the overall porosity and the range of mechanical properties are determined by a slurry composition and thus the amount and choice of polymer and ceramic filler (macroscale). Second, processing parameters like the freezing rate control both the lamellar spacing and the pore shape (microscale). Third, a particle size distribution and a polymer-to-ceramic ratio result in significantly different wall architectures.

A comparison to literature values obtained for similar but isotropic composite scaffold shows the tremendous potential of the freeze casting processing technique. The produced hybrid scaffolds cover the whole range of reported mechanical properties for one given porosity which proves the independance of mechanical properties from overall porosity can be achieved.

### Freeze Casting of Platelet-Based Slurries

Freeze casting capitalizes on directional solidification. When a solution or slurry is frozen, pure ice crystals form, rejecting dissolved or dispersed matter into intercrystalline spaces. Subsequent freeze-drying removes the ice but preserves the lamellar or tubular porosity that it templated. Directional solidification of the ice results in a honey-comblike structure with anisotropic mechanical properties. Material composition, additives and freezing rate allow to tune overall porosity, pore size and pore geometry. Water-based biopolymer solutions of chitosan and gelatin where used as both binders and polymer matrix. Ceramic particles of three different particle size distributions were added: small (ø 400 nm), large (ø 10 μm) and bimodal (70 vol % large, 30 vol % small). Hybrid scffolds were prepared using two different cooling rates: 1° C./min and 10° C./min.

Freeze casting of platelet-based slurries creates highly porous scaffolds with a nacre-like cell wall structure due to self-assembly during processing. The “cellular nacre” possesses properties considerably higher than those of composite scaffolds of the same composition made with spherical particles. They offer tremendous potential for use in applications, which require a combination of high porosity, stiffness, strength and toughness, such as filters, catalyst carriers and tissue scaffolds. Like its natural counterpart, the freeze-cast material benefits from a complex, hierarchical architecture that, up to now, has been difficult to emulate in bulk materials.

The freeze casting of platelet slurries produces highly porous cellular materials with self-assembled nacre-like cell walls and property profiles. The self-assembly happens during the ice-templating of the platelets that are of the same dimensions as the mineral building blocks in natural nacre (FIG. 23B). The directional solidification during freeze casting causes a phase separation to occur in the platelet-slurry. Lamellae of pure water-ice grow, alternating with lamellae of a ceramic-polymer composite, causing the platelets to self-assemble into a nacre-like structure. Once fully frozen, the ice phase is removed through sublimation with a freeze dryer, leaving behind a porous ceramic-polymer composite scaffold.

Two types of polymer solutions were prepared: 2.4% (w/v) low molecular chitosan (75-85% deacetylated, Sigma Aldrich, St. Louis, Mo., USA) and 5.5% (w/v) gelatin (type B, from bovine skin, Sigma Aldrich, St. Louis, Mo., USA) dissolved in 1% (v/v) acetic acid in distilled water. The chitosan solution was prepared on a bottle roller for 24 hrs at room temperature (25° C.); the gelatin solution was stirred on a hot plate at 40° C. for at least two hours. To obtain the final biopolymer solution, the two solutions were mixed at a 8:2 chitosan:gelatin solution volume ratio. This resulted in a solid weight ratio of 7:4 (chitosan:gelatin).

To prepare the ceramic slurry, 27% (w/v) of alumina powder consisting of either spherical particles or platelets were added to the chitosan-gelatin solution to achieve a dry weight ratio of 9:0.64:0.36 (alumina:chitosan:gelatin), or 9:1 (alumina:biopolymer). The alumina platelets had a diameter and a thickness of 5-10 μm and 300-500 nm respectively (Alusion™, Antaria Limited, Bentley, Western Australia). The spherical particle scaffolds were made either from small particles with a diameter of 400 nm (Ceralox SPA-RTP SB, Sasol North America Inc., Tucson, Ariz., USA), large particles with a diameter of 10 μm (Sigma Aldrich, St. Louis, Mo., USA), or a bimodal distribution with a 7:3 large:small particle volume ratio. The two particle sizes were chosen to match the thickness and the diameter of the platelets used in our study, which have dimensions that closely resemble those of the aragonite platelets in Abalone nacre.

Four different particle compositions—platelet, small, large and bimodal—were directionally solidified at two different freezing rates of 1° C./min and 10° C./min, corresponding to freezing front velocities of 7 μm/s and 28 m/s. After complete solidification, the samples were lyophilized for 48 hrs in a FreeZone 4.5 freeze dryer (Labconco, Kansas City, Mo., USA) at a pressure of 0.02 mBar and a water trap temperature of −52° C. The freeze-dried samples were cylindrical and had a diameter and height of 18 mm and 40 mm, respectively. The two freezing rates of 1° C./min and 10° C./min resulted in a lamellar spacing of 34 μm and 28 μm, respectively (FIG. 25). The overall sample porosity ranged from 90.2-91.8% and the composition of the cell wall solid was 75% alumina and 25% polymer by volume.

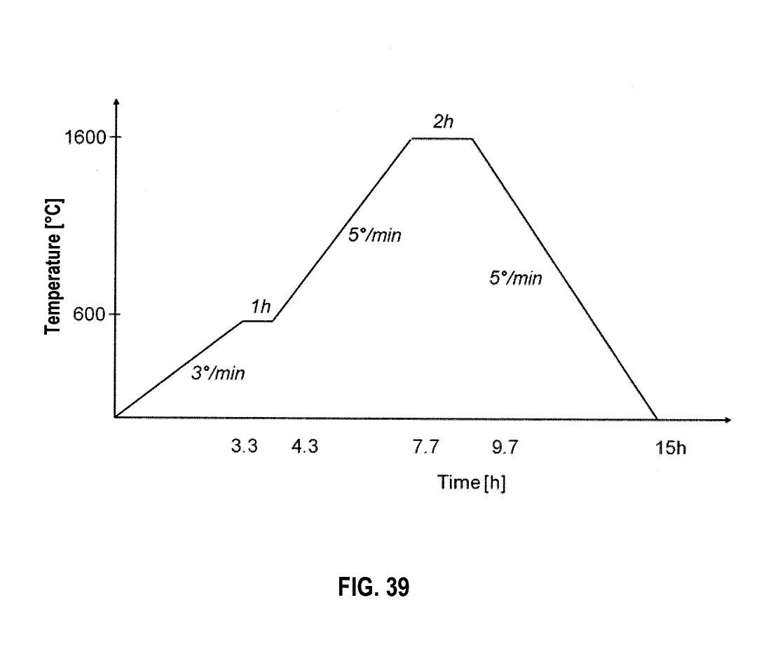

Both CAS and CAL samples had about the same volumetric composition:, i.e. 90% porosity, 7.6% Al₂O₃, and 1.5% chitosan, 0.9% gelatin After freeze-drying, both CAS and CAP samples had about the same outer diameter of 18.44 mm. They were sintered at identical conditions, actually, in the very same same sintering cycle. After sintering, the CAS sample has an outer diameter of 14.39 mm while the CAP sample has an outer diameter of 17.51 mm. The volumetric shrinkage for the CAS sample is 39% while the CAP sample had a volumetric shrinkage of only 10%. The linear shrinkage is 22% for small particles while for the platelets the linear shrinkage is 5%. FIG. 38 illustrates CAS and CAP samples. FIG. 39 shows a sintering cycle for CAS and CAP in an embodiment.

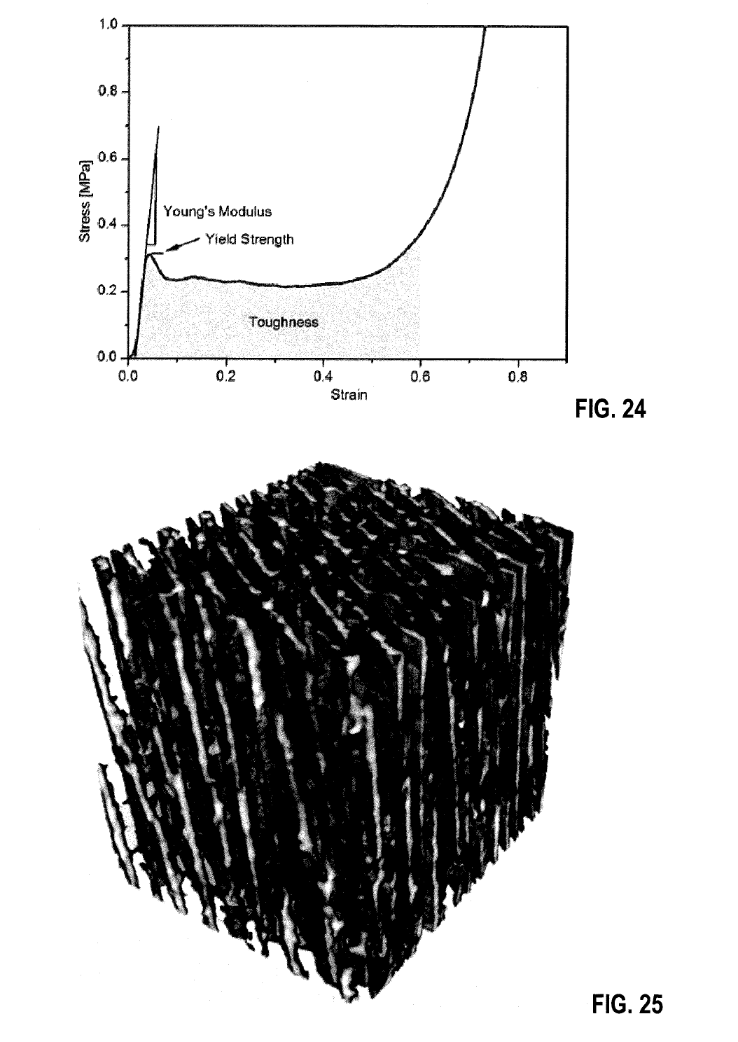

Mechanical Testing: Four cubes with 5 mm edge length were cut with a diamond wire saw (Model 4240, WELL Diamond Wire Saws, Inc., Norcross, Ga., USA) at three different sample heights, 7 mm, 17.5 mm and 28 mm, measured from the sample bottom to the cube center, yielding 12 cubes for each sample. At least three cubes for each height from three different cylindrical samples were tested for all four sample compositions. Mechanical testing was carried out in compression on a universal testing machine (Model 4442, Instron, Norwood, Mass., USA) with a 50 N load cell and a crosshead speed of 0.05 mm/s, corresponding to a strain rate of 0.01/s. A typical stress-strain curve is shown in FIG. 24. Young's modulus was calculated from the slope of the initial linear region, the yield strength was taken to be the peak stress before sample compaction. The toughness was calculated from the area underneath the compression curve up to a strain of 60%. The mechanical properties of the different scaffolds are listed in Tables 3 and 4.

Scanning Electron Microscopy (SEM) and Focused Ion Beam (FIB) Milling: Prior to imaging, the specimens were sputtered with platinum/palladium to achieve a coating thickness of about 3 nm. SEM micrographs were taken with an accelerating voltage of 6 kV at a working distance of 5 mm in a ZEISS Supra 50VP (Carl Zeiss SMT Inc., Peabody, Mass., USA). The cross-section of an individual cell wall, shown in FIG. 23C, was cut with a FIB system (Strata DB235, FEI Company, Hillsboro, Oreg., USA) using a beam current of 50 pA at an acceleration voltage of 30 kV. The specimens were transferred to the ZEISS Supra 50VP for imaging under the conditions described above.

In Situ Observation of Directional Solidification: Alumina platelets in chitosan-gelatin slurries were prepared as described above. Several drops of the slurry were pipetted onto a microscope slide, which was covered by a second slide to form a Hele-Shaw cell. The slides were compressed from both sides to achieve a uniform sample film thickness of about 100 μm. The Hele-Shaw cell was mounted horizontally in a custom-designed holder to expose the included slurry to a liquid nitrogen bath at one end of the microscope slides. Directional solidification started at this end, causing the nucleation and growth of ice crystals and the assembly of the dispersed and dissolved material, which was observed under a stereo microscope with a resolution of 476 nm (Leica M205, Leica Microsystems Inc., Buffalo Grove, Ill., USA). Videos were recorded with the Leica Application Suite and the MultiTime/Movie module.

X-ray Microtomography: Rectangular samples of 1 mm×1 mm×5 mm were cut with a diamond wire saw so that the 5 mm dimension was oriented parallel to the freezing direction. The sample was mounted upright on a cylindrical metal holder and placed in a SkyScan 1172 high-resolution desktop micro-computed tomography system (SkyScan, Kontich, Belgium). Radiographs were taken at a voltage of 59 kV, a current of 167 μA and a pixel size of 1.47 μm. An exposure time of 2356 ms and a frame averaging of 5 was used. The rotational step size was 0.15°. The SkyScan software NRecon was used for tomographic reconstruction. Volume renderings were prepared and visualized with the Avizo® Standard software package (VSG, Visualization Science Group, Inc., Burlington, Mass., USA).

TABLE 3
Mechanical properties of the alumina composites
frozen at a cooling rate of 1° C./min.

| | Freezing rate | | | |
|---|---|---|---|---|
| | 1° C./min | | | |
| | | Young's | Yield | |
| Alumina | Porosity | modulus | strength | Toughness |
| particle type | [%] | [MPa] | [MPa] | [MJ/m³] |
| Spherical, small | 91.4 ± 0.1 | 2.62 ± 0.75 | 0.100 ± 0.018 | 0.041 ± 0.012 |
| Ø: 400 nm | | | | |
| Spherical, biomodal | 90.8 ± 0.1 | 9.63 ± 1.61 | 0.244 ± 0.044 | 0.115 ± 0.031 |
| 30:70 (small:large) | | | | |
| Spherical, large | 90.5 ± 0.2 | 14.22 ± 4.36 | 0.270 ± 0.075 | 0.153 ± 0.019 |
| Ø: 10 μm | | | | |
| Platelets | 91.5 ± 0.1 | 27.44 ± 11.32 | 0.338 ± 0.057 | 0.213 ± 0.057 |
| Ø: 5-10 μm, | | | | |
| Thickness: 300-500 nm | | | | |

TABLE 4
Mechanical properties of the alumina composites
frozen at a cooling rate of 10° C./min.

| | Freezing rate | | | |
|---|---|---|---|---|
| | 10° C./min | | | |
| | | Young's | Yield | |
| Alumina | Porosity | modulus | strength | Toughness |
| particle type | [%] | [MPa] | [MPa] | [MJ/m³] |
| Spherical, small | 91.8 ± 0.1 | 7.08 ± 3.53 | 0.157 ± 0.061 | 0.087 ± 0.034 |
| Ø: 400 nm | | | | |
| Spherical, biomodal | 90.9 ± 0.1 | 20.05 ± 2.45 | 0.346 ± 0.023 | 0.170 ± 0.025 |
| 30:70 (small:large) | | | | |
| Spherical, large | 90.2 ± 0.1 | 12.11 ± 2.41 | 0.240 ± 0.017 | 0.143 ± 0.015 |
| Ø: 10 μm | | | | |
| Platelets | 91.6 ± 0.1 | 45.14 ± 11.92 | 0.723 ± 0.081 | 0.376 ± 0.090 |
| Ø: 5-10 μm, | | | | |
| Thickness: 300-500 nm | | | | |

The directional solidification of a platelet-containing chitosan-gelatin solution during freeze casting causes a phase separation to occur in the platelet slurry. Lamellae of pure water-ice grow and concentrate the ceramic-polymer slurry phase when water diffuses from the polymer solution to the ice-crystal surface. This gradually increases the polymer solution's viscosity until, ultimately, it vitrifies. As a result, the particles, which are initially very mobile in the liquid polymer solution, are subjected to an increasing drag as the viscosity increases. The ice crystals continue to grow, not only in length, but also in width, while the thickness of the ceramic-polymer phase between the ice lamellae decreases until the polymer reaches its glassy state. A 9% volumetric expansion occurs when the water solidifies into ice. Because the lateral expansion of the material is constrained by the mold, the volume increase of the solid phase must result in a flow of the, at this point, still liquid or viscous composite slurry. This flow causes the platelets to align and self-assemble.

FIG. 23A illustrates schematic of platelet self-assembly between ice crystals during directional solidification. FIG. 23B illustrates ice crystals (black) grow through the slurry along the direction of the temperature gradient. The lateral growth of the ice crystals concentrates the interlamellar ceramic-polymer composite (white). Scale bars are 100 μm. FIG. 23C illustrates scanning electron micrograph of an individual composite lamella. The cross-section of the nacre-like microstructure was created with a focused ion beam (FIB) system. It reveals the high degree of alignment of the platelets. Scale bar is 5 μm. FIG. 23C illustrates mechanical performance of the nacre-like composite scaffolds. Platelet scaffolds (P) are compared with scaffolds of the same composition made from small (S), bimodal (B) or large (L) spherical particles. Freezing rates were 1° C./min (black) and 10° C./min (red).

The cell walls had the desired brick-and-mortar structure of highly aligned platelets in a polymer matrix (FIGS. 23A and 23C). When comparing the mechanical properties of the “cellular nacre” with scaffolds made from spherical particles, the Young's modulus, yield-strength and toughness of the platelet scaffolds were found to be higher by a factor of two to four (FIG. 23D). Therefore, freeze casting of platelets provides significantly improved mechanical properties than freeze casting spherical particles.

FIG. 24 is a typical stress-strain curve of a freeze-cast scaffold tested in compression, indicating how Young's modulus, yield strength and toughness were determined.

FIG. 25 shows volume rendering of the cellular structure of a typical freeze-cast platelet scaffold. X-ray microtomography data visualized with the Avizo® Standard software package. Edge length of the cube is 500 μm.

The self-assembly of platelets into the observed brick-and-mortar structure is remarkable. Based on observations of the freezing process with a high resolution light microscope, it is possible that when the slurry is cooled and ice crystals start to form, water diffuses from the polymer solution to the ice-crystal surface. This may gradually increase the polymer solution's viscosity until, ultimately, it vitrifies. As a result, the particles, which are initially very mobile in the liquid polymer solution, are subject to increasing drag as the viscosity increases. The ice crystals grow in length and width, while the thickness of the ceramic-polymer phase between the ice lamellae decreases until the polymer reaches its glassy state (FIG. 23B). Noteworthy are convection currents ahead of the freezing front. Critical for the platelet self-assembly, however, is the shear flow in the ceramic-polymer composite between the ice lamellae paralleling the direction of solidification (see video in supporting online material). This shear flow is due to the 9% volumetric expansion of the slurry when the water solidifies into ice. Because the lateral expansion of the material is constrained by the mold, the volume increase of the ice phase must result in a flow of the, at this point, still liquid or viscous composite slurry. The flow is parallel to the direction of freezing and causes the platelets to align by shear and to self-assemble.

### Multifunctional Composite Material Using Hollow Micro-Spheres

Highly porous, multifunctional polymer-ceramic composites were “freeze cast” (directionally solidified) from a biopolymer solution that contained glass particles and beads. Optical and scanning electron microscopy confirmed the presence of highly aligned porosity; mechanical testing revealed high stiffness and strength per unit weight particularly in this direction. The high overall porosity also results in a low thermal conductivity and a high reflectance (>80%) in the visible and near infrared spectrum (250-2500 nm). All properties were found to depend on ceramic particle concentration, geometry and size. The purpose of the study was to explore the potential that renewable biopolymers and recycled glass particles and beads offer when freeze-cast into highly porous composites and structures that combine attractive optical, thermal and mechanical properties. Results showed ultra-low thermal conductivity values between 0.05-1 W/(m*k), excellent reflectivity (>85%) in the visible NIR range, and sufficient mechanical strength to sustain its own weight. Optical and SEM imagery clearly show the regular spacing of the pores and the alignment of the lamellae. X-ray tomography also confirms this. Industrially, the process is scalable, and the base component materials are inexpensive and relatively green. Applications include specialty needs for materials with low densities, low thermal conductivity, optically reflection and acoustically dampening.

Hollow glass microspheres (HGMS) are lightweight filler materials that have found much use to reinforce the mechanical properties of composite materials. They have also more recently found use as a form of infrared radiation shielding because of their reflective optical properties.

Freeze casting is one method by which porous composite materials are made. It consists of the directional freezing of an aqueous slurry containing composite components such as polymers, ceramic or metallic particles. The benefits of using an ice-template for the creation of a porous material is that it results in highly aligned porosity in the growing direction of the ice crystals. This alignment of the particles comes about by the lamellar structure formed by the ice which leads to a form of self-assembly. The self-assembly also brings about enhanced mechanical strength in the growth direction through a honey-comb like structure. Freeze-cast products may need to be lyophilized in order to achieve their porosity. Lyophilization is the process of freeze drying, which uses a vacuum pump to put the material under low pressure and remove the water via sublimation. Sublimation is the transition of a substance directly from its solid state to its gaseous phase, without going through the liquid phase. This direct transition from ice to gas reduces damage to the structure due to the formation of the liquid phase. The end result of the freeze-casting process is a highly aligned porous composite material, comprised of the non-aqueous components, packed together in a honey-comblike structure dependent on the starting water content and the freezing rate. These porous materials have been known to achieve porosities >90%, ultra light-weights compare to their solid counter parts and properties highly dependent on the material components within.

Highly porous materials like silica aerogels, for instance, have extremely low thermal conductivities. The average reported thermal conductivity of these aerogels is about 0.017 W/(m*K). In contrast, common materials like aluminum and air at room temperature (25° C.) have thermal conductivities of 150-220 W/(m*K) and 0.024 W/(m*K) respectively. Porous materials such as aerogels have low thermal conductivities, because solid conduction of heat is minimized due to the small geometric cross-sections inter-connecting the material. This means that heat must flow via either gaseous convection, transmission of infrared radiation, or gaseous molecular conduction lowering the material's overall thermal conductivity. Freeze-cast porous composites made from relatively insulative materials and possessing high porosities and low thermal conductivities.

Glass spheres may increase reflectance of visible and IR light. This occurs by light scattering in materials, which is primarily a function of three mechanisms, specular reflection, diffuse reflection, and total internal reflection. Specular reflection, or reflection off a mirror-like surface in a single direction, applies poorly to freeze-cast porous composite structures made of silicon micro bubbles and bio-polymer. Diffuse reflection is the scattering of light in many directions due to striking an uneven surface. Total internal reflection is an optical phenomenon that occurs when light is attempting to pass from a medium of higher index of refraction to one of lower index and is encouraged by the spherical geometry of the spheres. This internal reflection requires that the light hit at an angle of the incidence larger than the critical angle for that particular in order to be totally internally reflected. The freeze-cast porous samples may have diffuse reflectance and total internal reflection. Internal reflection may occur between the interface of the glass spheres and air. While porous structure itself, embedded with glass spheres will provide a roughened surface upon which diffuse reflectance occurs. This reflection of light in general may affect heat transfer through the material, possibly lowering the conductivity even more.

Three types of proprietary glass particles were acquired from Potters Industries Inc. including HGMS, 2.5 μm-diameter solid glass sphere (SGMS), and a 5 μm-diameter glass thin flake. Some properties of these particles can be found in Table 5. Four subdivisions or sample groups were designated from these particles. The four groups were: first a HGMS group, herein known as group 1, second 2.5 μm SGMS group, group 2, a thin flake group, group 3, and a bimodal group of both HGMS and 2.5 μm SGMS, group 4. For bimodal packing, particles with a ratio of 1:10 should be used. However due to limitations of the materials acquired, an average particle ratio of 1(SGMS):6(HGMS) must be used.

TABLE 5
Properties of Glass Particles

| | | | | | | Assumed | | Calculated |
|---|---|---|---|---|---|---|---|---|
| | | | Particle | Avg. | Avg. Wall | Thermal | Assumed | Avg. Density |
| | Product | | Diameter | | Thickness | Conductivity) | Density | Range |
| Name | Name | Geometry | (μm) | (μm) | (μm) | (λ~*^{m}^{^{−1}} ^{k}^{^{−1)}} | (g/cm) | (g/cm3) |
| HGMS | 110P8 | Spherical | 2-25 | 12 | 1.25 | 0.05** | 1.1 | 0.58-1.76 |
| SGMS | SG02S40* | Spherical | — | 2 | None | 1.14 | 2.5 | — |
| Thin | SG02TF40* | Platelet | — | 5 | 0.7 | 1.14 | 2.5 | — |
| Flakes | | | | | | | | |
| Chitosan | — | — | — | — | — | 0.25(15) | 1.0 | — |

Chitosan polymer is being used as the polymer phase. Chitosan is a green, renewable bio-polymer produced from the shells of crustaceans. It also happens to be the 2″ most abundant polysaccharide on the planet derived from Chitin found in crustaceans. Low molecular weight chitosan, 75-85% deacetylated, (Sigma Aldrich, St. Louis, Mo.) was used as received. A magnetic stirrer at 60 rpm for 24 hours was used to mix the chitosan solutions. After initial stirring of the solutions, they underwent shear mixing at a speed of 1600 rpm for 60 s in a DAC 150 FVZ-K SpeedMixer (FlackTek, Landrum, S.C.).

The glass particles were functionalized using a 3 Aminopropyltriethoxysilane(APTES)/acetone solution with a 1:10 ratio per milliliter of amine. 2.9 grams of glass particles were weighed using a Mettler Toledo Excellence Plus XP Analytical Balance and added to a 22 ml solution of APTES/acetone. The silane was acquired from Sigma Aldrich. The solution was then allowed to functionalize at room temperature for 2 hours, with slight agitation approximately every 30 minutes. To remove the HGMS and flake particles from solution, a Pyrex 4-5.5 μm ceramic filter was used in conjunction with a vacuum assisted round-bottom flask, to separate the un-functionalized APTES/acetone solution. The particles were then washed a minimum of 3 times to remove any remaining un-functionalized APTES. To remove the 2.5 μm SGMS particles from solution, a centrifuge was used to separate the particles from solution, which was then decanted. After being decanted, an additional 30 ml's of acetone was added and the solution agitated to wash the particles. The solution was centrifuged again and subsequently decanted. The SGMS's were washed three times in this way, before being left in a chemical fume hood overnight to dry.

Freeze-cast samples were made with 3.24 g of functionalized particles. For the Bimodal samples, a 70:30 ratio of 110P8:SGO2S40 was used, totaling 3.24 g. These particulate in powder form were then combined with 12 ml of chitosan solution, as mentioned previously, and mixed in a DAC 150 FVZ-K SpeedMixer for a total of 1.5 minutes at 1800 rpm. The resultant slurries were deposited into a polytetrafluoroethylene (PTFE) mold sealed at the base with a copper bottom. The mold was placed on top of the cold finger, while the top of the mold remained open to room temperature. The temperature of the cold finger was cooled at a controlled a rate of descent, 3° C./min, until it reached −180° C. This directionally solidified the sample, which as mentioned previously takes roughly 1.5 hours to complete. After complete solidification, the mold is removed from the cold-finger, and the copper base removed. The sample is then removed from the mold by a wooden punch and placed in a lyophilizer immediately.

The samples are characterized via mechanical, physical, thermal, and optical techniques. Mechanical testing is performed on Instron 4222 (Instron, Norwood, Mass.) using a 0.05 mm/sec cross-head speed and a 50 N load cell. Samples are prepared as a 5 mm×5 mm×5 mm cubes and tested compressively along the growing direction of the sample. Samples are tested dry and at room temperature (25° C.), although the option of wet testing is possible for future work. The Young's modulus and yield strength are determined from the resultant data. Two layers of four cubes per layer were cut and tested from each sample.

Physical characterization techniques include, optical microscopy using a Nikon light microscope, SEM imaging [(Zeiss Supra 50VP) with EDS (Oxford)] and X-ray Microtomography, to determine the structure and porosity. Overall porosity of the samples was determined by measuring the samples with calipers and weighing them on a high precision balance (XP105 Delta Range, Mettler Toledo Inc., Columbus, Ohio, readability=0.01 mg). Samples of approximate 3 mm×3 mm×2 mm dimensions were prepared for SEM imaging. Each sample was grounded with silver paint, and coated with a layer of platinum and graphite before being examined in the SEM. X-ray Micro-tomography was first performed on 5 mm×5 mm×5 mm cubes, and later changed to 2 mm×2 mm×2 mm cubes for higher resolution imaging. Optical images were taken from the same 5 mm×5 mm×5 mm cubes as used in the Instron.

For thermal properties, specific heat measurements are measured using a Quantum Design heat capacity measuring system, while thermal conductivity is measured by a Quantum Design P670 Thermal Transport System. The specific heat samples were prepared as 3×3×2 mm blocks. Thermal conductivity samples were prepared as 6 mm×6 mm×1 mm sheets. Two layers of thermal conductivity samples and specific heat samples were cut from each sample. One layer was taken from near the top of the sample, the other from near the bottom. Measurements were made at room temperature under high vacuum (<1 e⁻⁴ torr).

For optical reflectance, a Perkin Elmer Lambda 950 UV-Vis-NIR Spectrophotometer with a 60 mm integrating sphere attachment was used to determine and compare the reflectance of radiation in the 250 nm-2500 nm range of interest. Both deuterium and tungsten lamps were used to scan this wide range. This range incorporates the entirety of the visible light spectrum, as well as some wavelengths in the ultra-violet and near-infrared. A gain of 4 was used on the NIR detector with a response time of 0.2 s.

Optical properties were measured. The scan measured percent reflectance (% R) of the material, spanning from 250 nm to 2500 nm, a broad spectra of UV-Vis-NIR wavelengths. The samples were mounted on the blank side of a white 3×5 card with double sided scotch tape and covered by another 3×5 card with a cut out hole to the approximate size of the sample. This was done in an effort to minimize reflectance measurements off the double-sided tape, and to ensure that diffuse reflections were only coming off the white card and the sample. This simple rig was inserted into the opening of the diffuse reflectance sphere and held in place by spring-loaded arm.

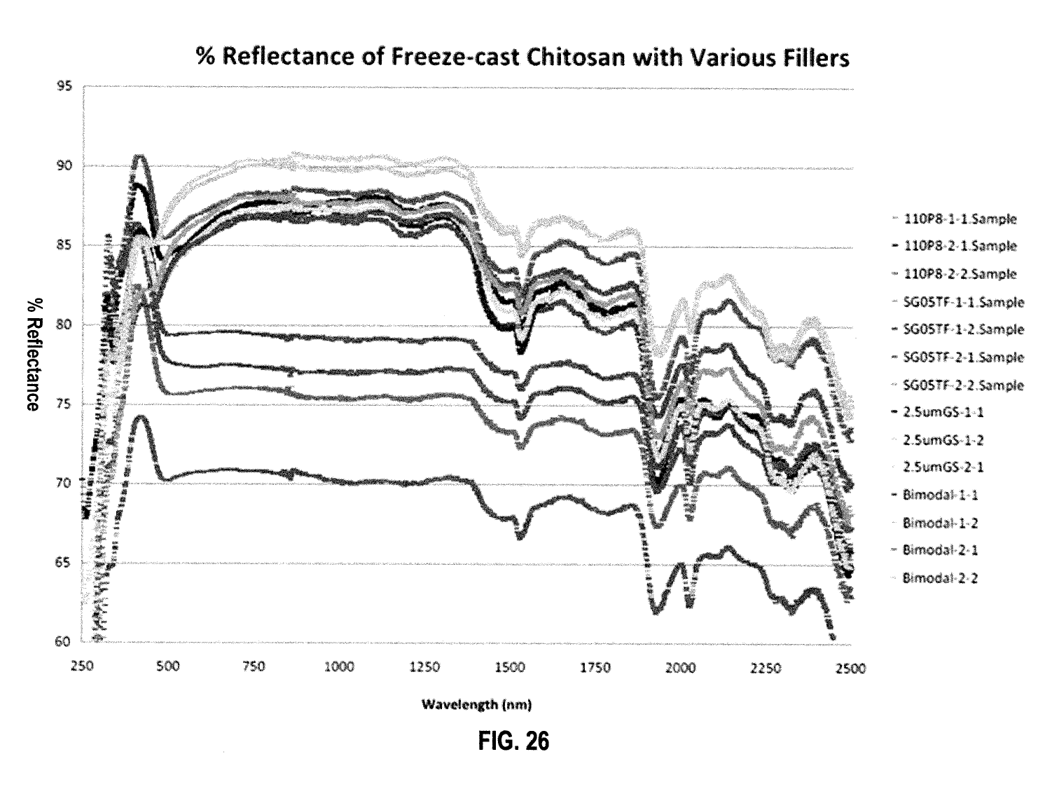

The machine was auto-zeroed with a standard Optical-grade Spectralon backing, a highly reflective fluoropolymer which according to its profile on the manufacturer's website (Labsphere) is >95% reflective in the 250 nm to 2500 nm range. Spectralon was also used as the reference material for every test. The results are shown in FIG. 26.

The data shows that the group with the best reflectance over the 250-2500 nm range was the 2″ layer bimodal samples. This group demonstrated approximately 88-89% reflectance or better over the 500 nm to 1400 nm range which includes the majority of the visible light spectrum and into the near infrared. This may be due the greatest range of sphere sizes, which means it should diffusely reflect the most via total internal reflection. The next largest grouping descending order of performance included the 110P8 layer 2 samples, bimodal layer 1 samples, SGMS layer 1 and 2 samples, and lastly 110P8 layer 1 samples. This tightly grouped, but clearly separate data suggests a few conclusions. That these samples performed at or near the same level of performance, between 83-85% reflectance over the 500-1400 nm range is obvious. Closer inspection reveals a trend that the 2″ layers within each group consistently outperformed the 1^{st} layers, even if only slightly for some groupings. This is an important observation because it may support the claim that some sedimentation is occurring. If this is true, then it would make sense that the 2^{nd} layers of more density packed spheres would reflect slightly more. This is supported by the both the bimodal and 110P8 samples. The SGMS samples, showed only marginally greater reflectance values for the 2^{nd} layer as compared to the first, however less sedimentation occurred for this sample, so it makes sense that the difference is not great. Another possible factor in the performance differences between the layers is the average pore size, where pores towards the base of the sample tended to be smaller on average than the pores near the top of the sample. This is likely caused by the thermal barrier to the advancing freezing front in the growing direction. This barrier slows the freezing down and causes the pores closer to the top of the sample to growth larger than the pores near the base which froze more expeditiously. The last group, the thin flakes samples, performed markedly worse than the other samples, but followed the same trend of the 2^{nd} layer outperforming the 1st layer.

Few quantitative results of thermal conductivity are available, as the samples were found to have so low a thermal conductivity that they are difficult to measure. Qualitatively, this means the performance of this material is in the order of the ultra-low conductivity Aerogels. For example, a HGMS sample, layer 1, was measured to have a heat capacity of 560 mJ/K and a thermal conductivity of 0.10 W*m⁻¹k⁻¹, while a Thin Flakes sample was measured to have a heat capacity of 590 mJ/K and a thermal conductivity of 0.056 W*m 1k−1.

Compression testing results of the 5 mm×5 mm×5 mm cubes are summarized in Table 6.

TABLE 6
Summary of Compression Testing Results.

| | | | Avg. | |
|---|---|---|---|---|
| | Avg. | | Yield | |
| | Modulus | | Str. | |
| Sample | [symbol] | STD | [symbol] | STD |
| HGMS layer 1 | 38.61 | 8.20 | 1.22 | 0.20 |
| HGMS layer 2 | 44.48 | 5.30 | 1.19 | 0.33 |
| SGMS layer 1 | 11.51 | 3.80 | 0.33 | 0.03 |
| SGMS SGMS | 9.29 | 1.80 | 0.23 | 0.02 |
| layer 2 | | | | |
| Thin Flake | 40.19 | 5.60 | 1.13 | 0.06 |
| layer 1 | | | | |
| Thin Flake | 37.42 | 9.70 | 1.19 | 0.10 |
| layer 2 | | | | |
| Bimodal layer 1 | 39.99 | 4.10 | 1.19 | 0.08 |
| Bimodal layer 2 | 42.90 | 4.80 | 1.08 | 0.15 |
| 100% Chitosan | 0.86 | 0.43 | 0.04 | 0.01 |

[symbol]

indicates data missing or illegible when filed

Two trends can be seen from the data collected. In the HGMS and Bimodal samples, a trend of increasing modulus is seen from layer 1 to layer 2. In the 2.5 μm SGMS and thin flakes samples, the opposite trend is observed; the layer 1 modulus is higher than layer 2. The trend data is unclear, and perhaps requires further repeat testing in order to extrapolate a good conclusion. What is clear though is that the 2.5 μm SGMS samples perform at about ¼^{th} the value of the rest, which have moduli around 40 MPa, and Yield strengths of approximately 1.10 MPa. This suggests that average particle size may play an important role in the reinforcement of the composite. It is clear from the data that the SGMS's alone made the sample much more brittle. Also, in comparison with just pure chitosan, the filler particles definitely increase mechanical strength as expected. The data suggests that particle volume plays a role in the mechanical reinforcement of the composite, and that the larger particles dominant the mechanical enhancement.

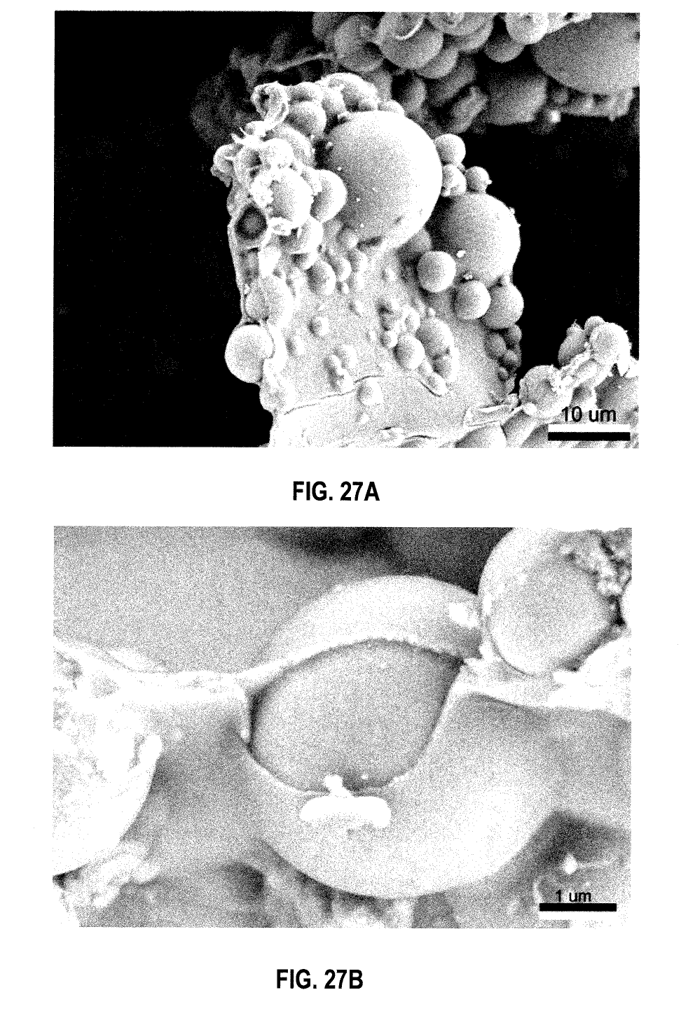

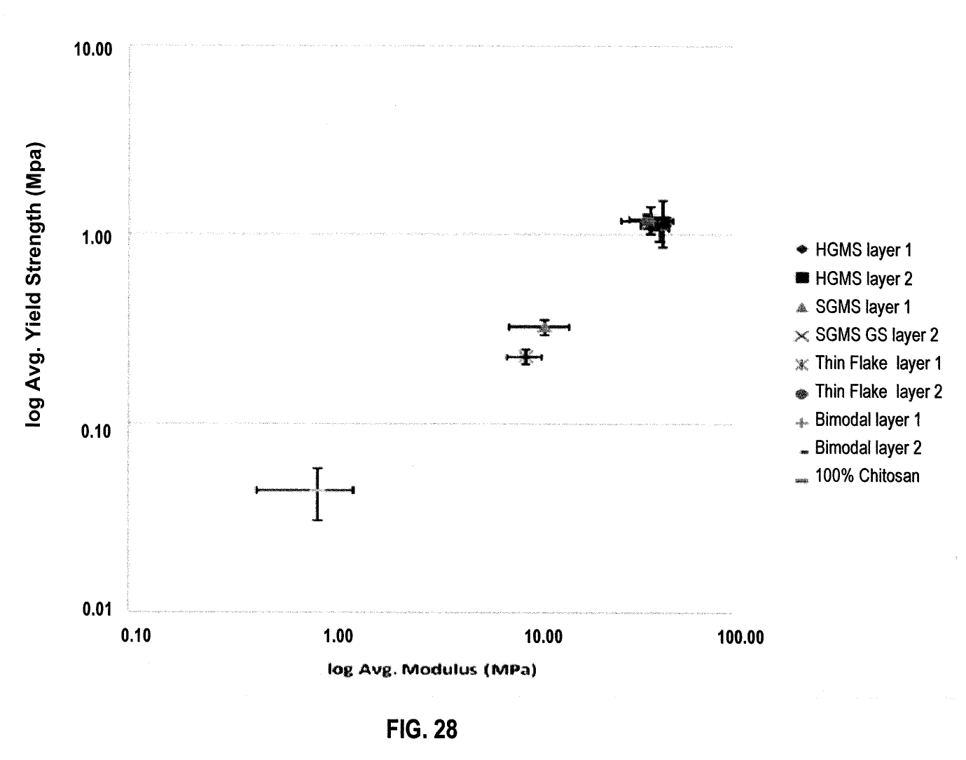

Optical microscopy of the all the samples revealed the evidence of clear lamellar spacing throughout all the sample groups. A closer inspection of the microstructure reveals some more insights as to how the material is held together. Good coverage of the HGMS encapsulated by chitosan polymer is shown in FIGS. 27A-27B. FIG. 28 is a plot of Log Avg. Yield Strength vs. Log Avg. Modulus for the samples.

In summary, the thermal conductivities were measured to be extremely low, between 0.05 and 0.1 W*^{m-1}*^{k-1}, as nearly as low as Aerogels. The reflectivity of the samples was characterized to be in the range of 80-89% in the visible and near IR range. The composite has also been shown to be mechanically and structurally stable able to support its own weight. Through freeze-casting, a highly aligned porous microstructure in a composite was also obtained. Optical and electron microscopy have both shown evidence of successfully aligned porosity and regular pore spacing, while X-ray tomography has shown the depth of the interpenetrating pores throughout the specimen.

Possible applications include, but not limited to, high-end thermal and radiation shielding, as well as thermally insulated applications. This material may find uses in high-end specialty applications that require low densities, low thermal conductivity, and acoustically dampening. Additionally, applications requiring heat retention may also find use for this composite material.

### Ice-Templated Nanocellulose Reinforced Composites

Tissue scaffolds, filters, and insulating materials required a high degree of porosity. However, the inclusion of porosity in a material significantly decreases the mechanical performance. Capitalizing on a directional, honey-comb-like structure allows for the maximization of mechanical properties while maintaining open porosity. The choice of materials and the use of freeze casting help achieve highly porous materials with independently tunable mechanical (stiffness, strength, toughness), structural (overall porosity, pore size), and chemical performance for a wide range of applications.

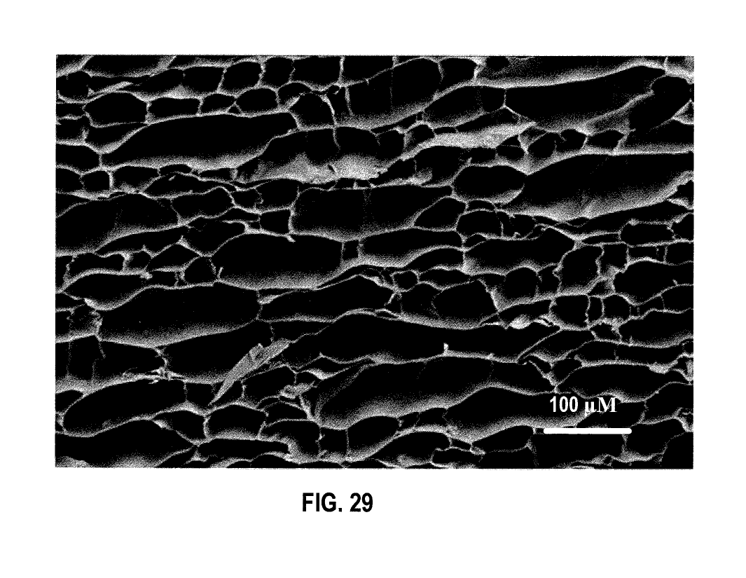

Nanocellulose fibers are derived from the load bearing cellulose fibers in plant cell walls, have diameters ranging from 4 to 40 nm. Chitosan is deacetylated chitin, which is the structural polysaccharide that provides the exoskeleton of insects and crustaceans with stiffness and strength. Nanoclay, or sodium montmorillonite, is a smectite clay platelet (ø=110 nm) and has been shown to reinforce composites at low weight percentages. Freeze casting capitalizes on directional solidification of water based solutions, where ice crystals template a lamellar or tubular structure. After freeze drying, a honey-comb-like, highly porous architecture remains. The hierarchical lamellar structure can be carefully controlled; where lamellar spacing λ, is inversely related to the freezing front velocity, v, raised to the power, n, where n is between 0.5 and 1 (See FIG. 29).

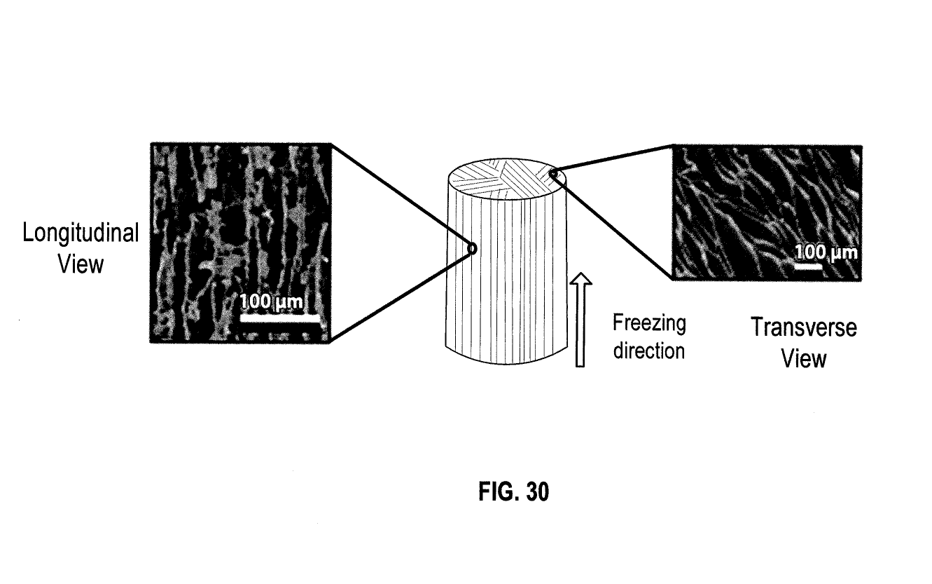

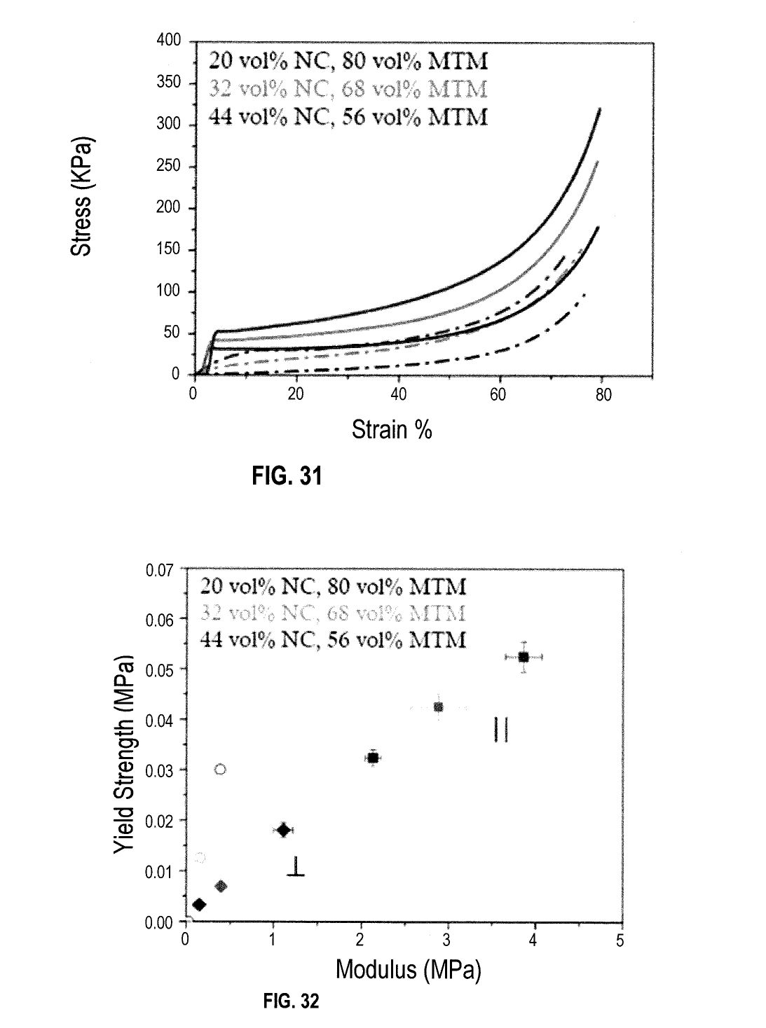

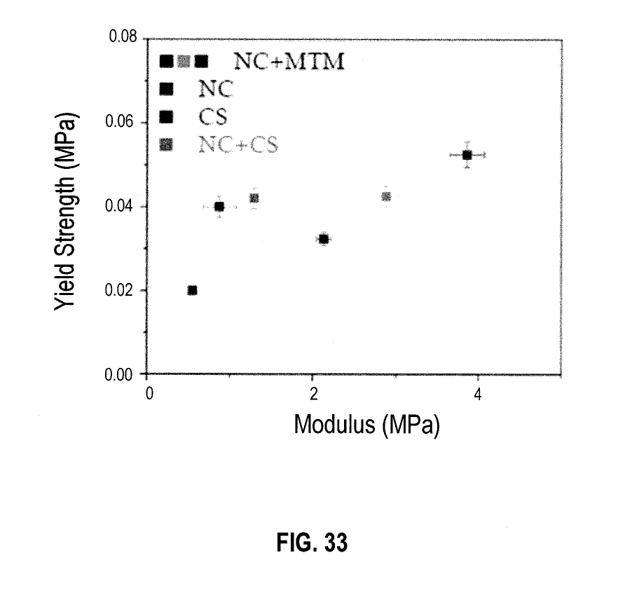

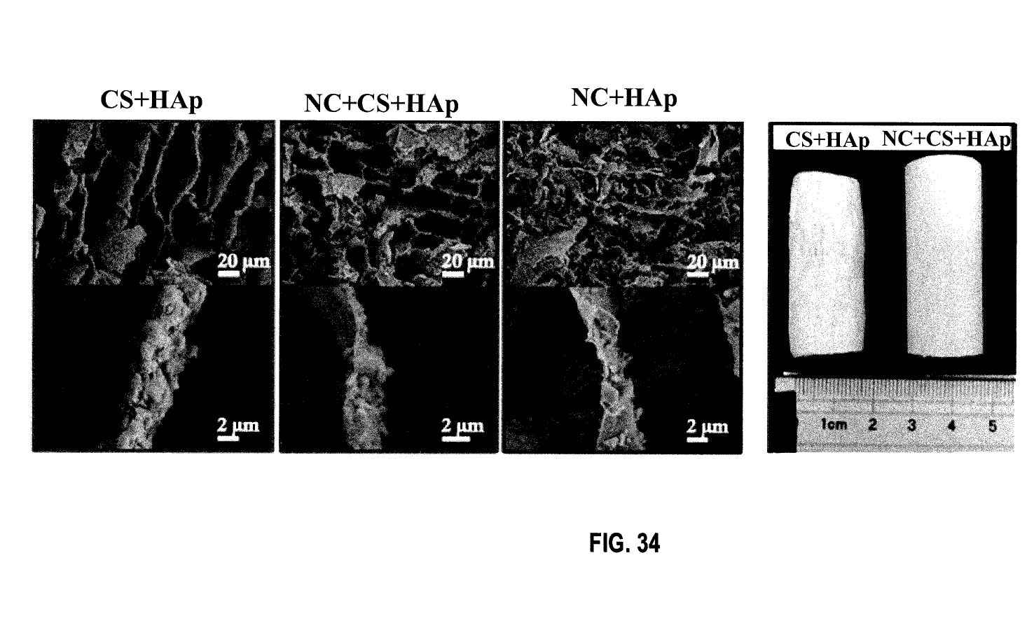

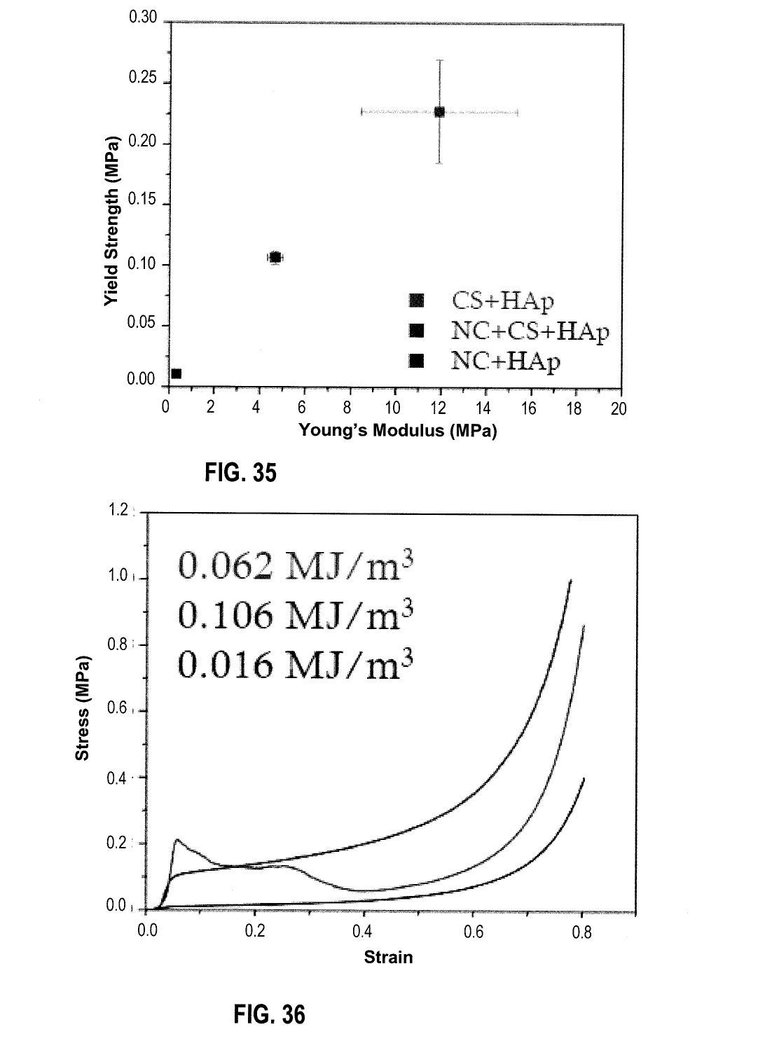

Freeze casting creates aligned open porosity in the direction parallel to the freezing direction (See FIG. 30). The structure is controlled through the freezing rate as well as through the constituent materials. Nanocellulose (NC), Chitosan (CS), Chitosan (CS)+Nanocellulose (NC), and Nanoclay (MTM)+Nanocellulose (NC) materials were used to investigate this structural difference, as well as the influence on mechanical performance. Anisotropic mechanical properties include strength, modulus, and toughness. Freeze cast scaffolds, in their strong direction, outperform isotropic foams at the same composition and porosity with respect to their Young's modulus (stiffness), strength, and toughness (i.e. work to fracture) (See FIG. 31).

Nanocellulose (NC) improves both Young's modulus and yield strength in chitosan (CS) and nanoclay(MTM) based materials (See FIG. 32, where dashline are for a traverse direction and solid lines are for longitudinal direction). Anisotropic freeze casting scaffolds tested parallel to freezing direction. Anisotropic freeze cast scaffolds tested perpendicular to freezing direction.

Nanocelluose can further increase the toughness and structural stability of hydroxyapatite (HAp) materials for applications as bone tissue scaffolds. At an overall porosity of 95.5% with same particle loading, Nanocellulose reinforced chitosan and hydroxyapatite scaffolds showed the highest toughness (inset).

Freeze casting, or ice-templating, allows for the creation of directional structure, interconnected porosity, with maximized mechanical properties. Reinforcement with nanocellulose yields enhanced mechanical properties, especially toughness.

### Freeze Casting for Fast Reactor Fuels

Advanced burner reactors are designed to reduce the amount of long-lived radioactive isotopes that need to be disposed of as waste. The input feedstock for creating advanced fuel forms comes from either recycle of used light water reactor fuel or recycle of fuel from a fast burner reactor. Fuel for burner reactors requires novel fuel types based on new materials and designs that can achieve higher performance requirements (higher burn up, higher power, and greater margins to fuel melting) than currently achieved. One promising strategy to improved fuel performance is the manufacture of metal or ceramic scaffolds that are designed to allow for a well defined placement of the fuel into a host, which permits greater control than that possible in the production of typical CERMET fuels.

In an embodiment, a nuclear fuel may be placed into the metal honey-comb structures as the basis of a CERMET fuel or a purely metallic fuel. In another embodiment, ceramic honey-comb structures are formed as the basis of an inert matrix fuel (IMF) form or a form for containing isotopes targeted for geologic disposal. The metal honey-comb structures and the ceramic honey-comb structures are formed by the freeze-casting, or ice-templating, which enables establishing a range of flexible and controllable fuel pellet designs.

Having described several embodiments, it would be recognized by those skilled in the art that various modifications, alternative constructions, and equivalents may be used without departing from the spirit of the invention. Additionally, a number of well-known processes and elements have not been described in order to avoid unnecessarily obscuring of the present invention. Accordingly, the above description should not be taken as limiting the scope of the invention.

Those skilled in the art will appreciate that the presently disclosed instrumentalities teach by way of example and not by limitation. Therefore, the matter contained in the above description or shown in the accompanying drawings should be interpreted as illustrative and not in a limiting sense. The following claims are intended to cover all generic and specific features described herein, as well as all statements of the scope of the present method and system, which, as a matter of language, might be said to fall therebetween.

What is claimed is:

1. A metal-polymer composite scaffold, comprising:
metal particles coupled with polymer binder, the scaffold having regions of aligned porosity with a gradient.

2. The metal-polymer composite scaffold of claim 1, wherein the metal particles comprise stainless steel.

3. The metal-polymer composite scaffold of claim 2, wherein the metal particles have sizes equal to or smaller than 3 mm.

4. The metal-polymer composite scaffold of claim 3, wherein the scaffold has Young's modulus is below 950 MPa.

5. The metal-polymer composite scaffold of claim 1, wherein the polymer binder comprises chitosan and gelatin.

6. The metal-polymer composite scaffold of claim 1, wherein the composite comprises ethanol.

7. The metal-polymer composite scaffold of claim 1, wherein the composite has a porosity of at least 70%.

8. A ceramic-polymer composite, comprising:
alumina; and
polymer binder, the composite having regions of aligned porosity with a gradient.

9. The ceramic-polymer composite of claim 8, wherein the composite has a porosity of at least 90%.

10. The ceramic-polymer composite of claim 8, wherein the polymer binder comprises chitosan and gelatin.

11. The ceramic-polymer composite of claim 8, wherein the alumina is in a form of particles or platelets.

12. The ceramic-polymer composite of claim 11, wherein the composite formed with the alumina in the form of platelets has less shrinkage and improved yield strength and Young's modulus than a ceramic-polymer composite formed with the alumina in the form of particles.

13. The ceramic-polymer composite of claim 11, wherein the alumina particles have diameters in the range of a few hundred nms.

14. The ceramic-polymer composite of claim 11, wherein the alumina particles have diameters in the range of approximately 10 μm.

15. The ceramic-polymer composite of claim 11, wherein the alumina particles comprise a first portion of particles with diameters in the range of a few hundred nms and a second portion of particles with diameters in the range of approximately 10 μm

16. A multi-functional polymer-ceramic composite, the composite comprising:
glass beads; and
polymer binder; the composite having regions of aligned porosity with a gradient.

17. The multi-functional polymer-ceramic composite of claim 16, wherein the glass beads are selected from a group consisted of hollow beads, solid beads, and flakes.

18. The multi-functional polymer-ceramic composite of claim 16, wherein the polymer binder comprises chitosan.

19. The multi-functional polymer-ceramic composite of claim 16, wherein the composite has a reflectivity above 80% in a visible and IR spectra ranging from 250 nm to 2500 nm.

20. The multi-functional polymer-ceramic composite of claim 16, wherein the composite has thermal conductivity below 0.1 W*m−1K−1.

21. The multi-functional polymer-ceramic composite of claim 16, wherein the glass beads have sizes ranging from 2 μm to 25 μm.
